(19) United States
(12) Patent Application Publication
(10) Pub. No.: US 2024/0382963 A1
(43) Pub. Date: Nov. 21, 2024

(54) DIGITAL MICROFLUIDICS (DMF) SYSTEM, INSTRUMENT, AND CARTRIDGE INCLUDING MULTI-SIDED DMF DISPENSING AND METHOD

(71) Applicant: Nicoya Lifesciences Inc., Kitchener (CA)

(72) Inventors: Champika SAMARASEKERA, Guelph (CA); Tanya NARAHARI, Kitchener (CA)

(21) Appl. No.: 18/693,878

(22) PCT Filed: Sep. 19, 2022
(86) PCT No.: PCT/CA2022/051383

§ 371 Date: Mar. 20, 2024

Related U.S. Application Data
(60) Provisional application No. 63/246,121, filed on Sep. 20, 2021.

(51) Int. Cl. B01L 3/00

(52) U.S. Cl. CPC B01L 3/502784; B01L 2200/0673; B01L 2200/16; B01L 2300/027; B01L 2300/0645

(57) ABSTRACT

In some aspects, the presently disclosed subject matter provides a microfluidics system, instrument, and cartridge including multi-sided digital microfluidic (DMF) dispensing and method of use. In other aspects, the presently disclosed invention is directed to computer readable storage medium comprising instructions, which to: load a multi outlet digital microfluidic device dispenser with a liquid; dispense a first portion of the liquid from a first outlet; dispense a second portion of the liquid from a second outlet; perform a first analysis on the first portion of the liquid; perform a second analysis on the second portion of the liquid; and present results of the first analysis.

### FIELD OF THE INVENTION

The presently disclosed subject matter relates generally to optical fiber interfaces and more particularly to a digital microfluidics (DMF) system, instrument, and cartridge including multi-sided or multi-outlet DMF dispensing and method of use.

### BACKGROUND

DMF systems and devices are used in a variety of applications to manipulate, process and/or analyze biological materials. For example, DMF systems and devices are used to perform COVID-19 assays. However, in DMF-based COVID-19 assays, certain processes take a long amount of time. For example, processes such as (1) mixing and (2) transporting droplets via droplet operations to the various locations of the DMF cartridge may require long processing times, which adversely affects throughput. Accordingly, new approaches are needed with respect to improving the throughput of DMF-based processes.

### SUMMARY

In some aspects, the presently disclosed invention is directed to a method, the method comprising: loading a multi outlet digital microfluidic device dispenser with a liquid; dispensing a first portion of the liquid from a first outlet; dispensing a second portion of the liquid from a second outlet; performing a first analysis on the first portion of the liquid; performing a second analysis on the second portion of the liquid; and presenting results of the first analysis and/or the second analysis.

In some embodiments, the first portion of the liquid is roughly the same amount as the second portion of the liquid.

In some embodiments, a first portion of the multi outlet digital microfluidic device dispenser includes a height that is different from a second portion of the multi outlet digital microfluidic device.

In some embodiments, the method further comprises presenting results of the second analysis.

In some embodiments, the first analysis and the second analysis are the same analysis.

In some embodiments, the method further comprises dispensing the first portion of the liquid from a first outlet includes dispensing the first portion of the liquid to a first track. In some embodiments, dispensing the second portion of the liquid from a second outlet includes dispensing the second portion of the liquid to a second track.

In some aspects, the present invention is directed to a system, the system comprising: a multi outlet digital microfluidic device dispenser; a graphical user interface; and a processor configured to: load the multi outlet digital microfluidic device dispenser with a liquid; dispense a first portion of the liquid from a first outlet; dispense a second portion of the liquid from a second outlet; perform a first analysis on the first portion of the liquid; perform a second analysis on the second portion of the liquid; and present results of the first analysis and/or the second analysis on the graphical user interface.

In some embodiments, the first portion of the liquid is roughly the same amount as the second portion of the liquid.

In some embodiments, a first portion of the multi outlet digital microfluidic device dispenser includes a height that is different from a second portion of the multi outlet digital microfluidic device.

In some embodiments, the processor further configured to present results of the second analysis.

In some embodiments, the first analysis and the second analysis are the same analysis.

In some embodiments, dispensing the first portion of the liquid from a first outlet includes dispensing the first portion of the liquid to a first track.

In some embodiments, dispensing the second portion of the liquid from a second outlet includes dispensing the second portion of the liquid to a second track.

In some aspects, the presently disclosed invention is directed to a non-volatile computer readable storage medium comprising instructions, which when executed by a processing device, causes the processing device to: load a multi outlet digital microfluidic device dispenser with a liquid; dispense a first portion of the liquid from a first outlet; dispense a second portion of the liquid from a second outlet; perform a first analysis on the first portion of the liquid; perform a second analysis on the second portion of the liquid; and present results of the first analysis and/or second analysis.

In some embodiments, the first portion of the liquid is roughly the same amount as the second portion of the liquid.

In some embodiments, a first portion of the multi outlet digital microfluidic device dispenser includes a height that is different from a second portion of the multi outlet digital microfluidic device.

In some embodiments, the processor further configured to present results of the second analysis.

In some embodiments, wherein the first analysis and the second analysis are the same analysis.

In some embodiments, dispensing the first portion of the liquid from a first outlet includes dispensing the first portion of the liquid to a first track.

In some embodiments, dispensing the second portion of the liquid from a second outlet includes dispensing the second portion of the liquid to a second track.

In some aspects, the presently disclosed invention is directed to a microfluidic cartridge, the cartridge comprising: (a) a top substrate; (b) a bottom substrate, the bottom substrate having a plurality of droplet operations electrodes, wherein the top substrate and bottom substrate are space apart from the bottom substrate forming a droplet operations gap therebetween; and (c) a plurality of multi-outlet dispensers operable to dispense a liquid; and wherein said droplet operations electrodes include a plurality of dispending electrodes leading away from each of the plurality of multi-outlet dispensers.

In some embodiments, the plurality of multi-outlet dispensers includes one or more dual-sided dispensers, wherein the dual-sided dispensers are operable to dispense a liquid from two outlets, a first outlet and a second outlet.

In some embodiments, the plurality of multi-outlet dispensers includes one or more triple-sided dispensers, wherein the triple-sided dispensers are operable to dispense a liquid from three outlets, a first outlet, a second outlet, and a third outlet.

In some embodiments, the plurality of multi-outlet dispensers includes one or more quad-sided dispensers, wherein the quad-sided dispensers are operable to dispense a liquid from four outlets, a first outlet, a second outlet, a third outlet, and a fourth outlet.

In some embodiments, the plurality of multi-outlet dispensers are arranged in an array, and wherein the array comprises one or more rows and/or one or more columns of multi-outlet dispensers.

In some embodiments, the cartridge further comprises one or more reservoirs, wherein the one or more reservoirs are in fluid communication with the plurality of multi-outlet dispensers. droplet operations electrodes.

In some embodiments, the cartridge further comprises one or more detection mechanisms in fluid communication with the plurality of multi-outlet dispensers.

In some embodiments, the fluid communication comprises one or more of the droplet operations electrodes.

In some embodiments, each of the plurality of multi-outlet dispensers includes a liquid reagent or a liquid sample, and optionally wherein the liquid reagent is selected from a wash buffer, a ligand-containing reagent, an antigen-containing reagent, or a reactant-containing reagent.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 illustrates a block diagram of an example of a microfluidics system including a DMF cartridge further including multi-sided DMF dispensers;

FIG. 2A and FIG. 2B illustrate plan views of an example of a dual-sided dispenser, which is one example of the multi-sided DMF dispensers of the microfluidics system shown in FIG. 1;

FIG. 3A and FIG. 3B illustrate plan views of an example of using the dual-sided dispenser shown in FIG. 2A and FIG. 2B;

FIG. 4 illustrates a flow diagram of an example of a method of using the multi-sided DMF dispensers according to a simplest configuration;

FIG. 5 illustrates a block diagram of an example of an array or matrix of the dual-sided dispensers shown in FIG. 2A and FIG. 2B;

FIG. 6 illustrates a plan view of an example of a 4×4 portion of an array or matrix of dual-sided dispensers according to one configuration;

FIG. 7 through FIG. 32 illustrate plan views of an electrode arrangement including an array or matrix of dual-sided dispensers according to another configuration and showing an example of a magnetic bead assay using the dual-sided dispensers;

FIG. 33 illustrates a flow diagram of an example of a method of performing an assay using the presently disclosed microfluidics system including the dual-sided DMF dispensers;

FIG. 34 illustrates a plan view of an example of a triple-sided dispenser, which is another example of the multi-sided DMF dispensers of the microfluidics system shown in FIG. 1;

FIG. 35 illustrates a plan view of an example of a quad-sided dispenser, which is another example of the multi-sided DMF dispensers of the microfluidics system shown in FIG. 1;

FIG. 36 illustrates a plan view of another example of a dual-sided dispenser;

FIG. 37 illustrates a plan view of an example of a mixer array arranged with respect to multiple dual-sided dispensers;

FIG. 38 illustrates a side view of an example of a DMF structure including a dual-sided dispenser that can include multiple gap heights to facilitate simultaneous dual-sided dispensing; and

FIG. 39A through FIG. 39F illustrates side views showing an example of a simultaneous dual-sided dispense process using the dual-sided dispenser of the DMF structure shown in FIG. 38.

### DEFINITIONS

“Activate,” with reference to one or more electrodes, means affecting a change in the electrical state of the one or more electrodes which, in the presence of a droplet, results in a droplet operation. Activation of an electrode can be accomplished using alternating current (AC) or direct current (DC). Any suitable voltage may be used. For example, an electrode may be activated using a voltage which is greater than about 5 V, or greater than about 20 V, or greater than about 40 V, or greater than about 100 V, or greater than about 200 V or greater than about 300 V. The suitable voltage being a function of the dielectric's properties such as thickness and dielectric constant, liquid properties such as viscosity and many other factors as well. Where an AC signal is used, any suitable frequency may be employed. For example, an electrode may be activated using an AC signal having a frequency from about 1 Hz to about 10 MHz, or from about 1 Hz and 10 KHz, or from about 10 Hz to about 240 Hz, or about 60 Hz.

“Droplet” means a volume of liquid on a droplet actuator. Typically, a droplet is at least partially bounded by a filler fluid. For example, a droplet may be completely surrounded by a filler fluid or may be bounded by filler fluid and one or more surfaces of the droplet actuator. As another example, a droplet may be bounded by filler fluid, one or more surfaces of the droplet actuator, and/or the atmosphere. As yet another example, a droplet may be bounded by filler fluid and the atmosphere. Droplets may, for example, be aqueous or non-aqueous or may be mixtures or emulsions including aqueous and non-aqueous components. Droplets may take a wide variety of shapes; nonlimiting examples include generally disc shaped, slug shaped, truncated sphere, ellipsoid, spherical, partially compressed sphere, hemispherical, ovoid, cylindrical, combinations of such shapes, and various shapes formed during droplet operations, such as merging or splitting or formed as a result of contact of such shapes with one or more surfaces of a droplet actuator. For examples of droplet fluids that may be subjected to droplet operations using the approach of the invention, see International Patent Application No. PCT/US 06/47486, entitled, “Droplet-Based Biochemistry,” filed on Dec. 11, 2006. In various embodiments, a droplet may include a biological sample, such as whole blood, lymphatic fluid, serum, plasma, sweat, tear, saliva, sputum, cerebrospinal fluid, amniotic fluid, seminal fluid, vaginal excretion, serous fluid, synovial fluid, pericardial fluid, peritoneal fluid, pleural fluid, transudates, exudates, cystic fluid, bile, urine, gastric fluid, intestinal fluid, fecal samples, liquids containing single or multiple cells, liquids containing organelles, fluidized tissues, fluidized organisms, liquids containing multi-celled organisms, biological swabs and biological washes. Moreover, a droplet may include a reagent, such as water, deionized water, saline solutions, acidic solutions, basic solutions, detergent solutions and/or buffers. Other examples of droplet contents include reagents, such as a reagent for a biochemical protocol, such as a nucleic acid amplification protocol, an affinity-based assay protocol, an enzymatic assay protocol, a sequencing protocol, and/or a protocol for analyses of biological fluids. A droplet may include one or more beads.

“Droplet Actuator” means a device for manipulating droplets, such as a digital microfluidics (DMF) device or cartridge. For examples of droplet actuators, see Pamula et al., U.S. Pat. No. 6,911,132, entitled “Apparatus for Manipulating Droplets by Electrowetting-Based Techniques,” issued on Jun. 28, 2005; Pamula et al., U.S. patent application Ser. No. 11/343,284, entitled “Apparatuses and Methods for Manipulating Droplets on a Printed Circuit Board,” filed on filed on Jan. 30, 2006; Pollack et al., International Patent Application No. PCT/US2006/047486, entitled “Droplet-Based Biochemistry,” filed on Dec. 11, 2006; Shenderov, U.S. Pat. No. 6,773,566, entitled “Electrostatic Actuators for Microfluidics and Methods for Using Same,” issued on Aug. 10, 2004 and U.S. Pat. No. 6,565,727, entitled “Actuators for Microfluidics Without Moving Parts,” issued on Jan. 24, 2000; Kim and/or Shah et al., U.S. patent application Ser. No. 10/343,261, entitled “Electrowetting-driven Micropumping,” filed on Jan. 27, 2003, Ser. No. 11/275,668, entitled “Method and Apparatus for Promoting the Complete Transfer of Liquid Drops from a Nozzle,” filed on Jan. 23, 2006, Ser. No. 11/460,188, entitled “Small Object Moving on Printed Circuit Board,” filed on Jan. 23, 2006, Ser. No. 12/465,935, entitled “Method for Using Magnetic Particles in Droplet Microfluidics,” filed on May 14, 2009, and Ser. No. 12/513,157, entitled “Method and Apparatus for Real-time Feedback Control of Electrical Manipulation of Droplets on Chip,” filed on Apr. 30, 2009; Velev, U.S. Pat. No. 7,547,380, entitled “Droplet Transportation Devices and Methods Having a Fluid Surface,” issued on Jun. 16, 2009; Sterling et al., U.S. Pat. No. 7,163,612, entitled “Method, Apparatus and Article for Microfluidic Control via Electrowetting, for Chemical, Biochemical and Biological Assays and the Like,” issued on Jan. 16, 2007; Becker and Gascoyne et al., U.S. Pat. Nos. 7,641,779, entitled “Method and Apparatus for Programmable fluidic Processing,” issued on Jan. 5, 2010, and U.S. Pat. No. 6,977,033, entitled “Method and Apparatus for Programmable fluidic Processing,” issued on Dec. 20, 2005; Decre et al., U.S. Pat. No. 7,328,979, entitled “System for Manipulation of a Body of Fluid,” issued on Feb. 12, 2008; Yamakawa et al., U.S. Patent Pub. No. 20060039823, entitled “Chemical Analysis Apparatus,” published on Feb. 23, 2006; Wu, International Patent Pub. No. WO/2009/003184, entitled “Digital Microfluidics Based Apparatus for Heat-exchanging Chemical Processes,” published on Dec. 31, 2008; Fouillet et al., U.S. Patent Pub. No. 20090192044, entitled “Electrode Addressing Method,” published on Jul. 30, 2009; Fouillet et al., U.S. Pat. No. 7,052,244, entitled “Device for Displacement of Small Liquid Volumes Along a Micro-catenary Line by Electrostatic Forces,” issued on May 30, 2006; Marchand et al., U.S. Patent Pub. No. 20080124252, entitled “Droplet Microreactor,” published on May 29, 2008; Adachi et al., U.S. Patent Pub. No. 20090321262, entitled “Liquid Transfer Device,” published on Dec. 31, 2009; Roux et al., U.S. Patent Pub. No. 20050179746, entitled “Device for Controlling the Displacement of a Drop Between two or Several Solid Substrates,” published on Aug. 18, 2005; Dhindsa et al., “Virtual Electrowetting Channels: Electronic Liquid Transport with Continuous Channel Functionality,” Lab Chip, 10:832-836 (2010); the entire disclosures of which are incorporated herein by reference, along with their priority documents. Certain droplet actuators will include one or more substrates arranged with a droplet operations gap therebetween and electrodes associated with (e.g., layered on, attached to, and/or embedded in) the one or more substrates and arranged to conduct one or more droplet operations. For example, certain droplet actuators will include a base (or bottom) substrate, droplet operations electrodes associated with the substrate, one or more dielectric layers atop the substrate and/or electrodes, and optionally one or more hydrophobic layers atop the substrate, dielectric layers and/or the electrodes forming a droplet operations surface. A top substrate may also be provided, which is separated from the droplet operations surface by a gap, commonly referred to as a droplet operations gap. Various electrode arrangements on the top and/or bottom substrates are discussed in the above-referenced patents and applications and certain novel electrode arrangements are discussed in the description of the invention. During droplet operations it is preferred that droplets remain in continuous contact or frequent contact with a ground or reference electrode. A ground or reference electrode may be associated with the top substrate facing the gap, the bottom substrate facing the gap, in the gap. Where electrodes are provided on both substrates, electrical contacts for coupling the electrodes to a droplet actuator instrument for controlling or monitoring the electrodes may be associated with one or both plates. In some cases, electrodes on one substrate are electrically coupled to the other substrate so that only one substrate is in contact with the droplet actuator. In one embodiment, a conductive material (e.g., an epoxy, such as MASTER BOND™ Polymer System EP79, available from Master Bond, Inc., Hackensack, NJ) provides the electrical connection between electrodes on one substrate and electrical paths on the other substrates, e.g., a ground electrode on a top substrate may be coupled to an electrical path on a bottom substrate by such a conductive material. Where multiple substrates are used, a spacer may be provided between the substrates to determine the height of the gap therebetween and define on-actuator dispensing reservoirs. The spacer height may, for example, be from about 5 μm to about 1000 μm, or about 100 μm to about 400 μm, or about 200 μm to about 350 μm, or about 250 μm to about 300 μm, or about 275 μm. The spacer may, for example, be formed of a layer of projections form the top or bottom substrates, and/or a material inserted between the top and bottom substrates. One or more openings may be provided in the one or more substrates for forming a fluid path through which liquid may be delivered into the droplet operations gap. The one or more openings may in some cases be aligned for interaction with one or more electrodes, e.g., aligned such that liquid flowed through the opening will come into sufficient proximity with one or more droplet operations electrodes to permit a droplet operation to be effected by the droplet operations electrodes using the liquid. The base (or bottom) and top substrates may in some cases be formed as one integral component. One or more reference electrodes may be provided on the base (or bottom) and/or top substrates and/or in the gap. Examples of reference electrode arrangements are provided in the above referenced patents and patent applications. In various embodiments, the manipulation of droplets by a droplet actuator may be electrode mediated, e.g., electrowetting mediated or dielectrophoresis mediated or Coulombic force mediated. Examples of other techniques for controlling droplet operations that may be used in the droplet actuators of the invention include using devices that induce hydrodynamic fluidic pressure, such as those that operate on the basis of mechanical principles (e.g. external syringe pumps, pneumatic membrane pumps, vibrating membrane pumps, vacuum devices, centrifugal forces, piezoelectric/ultrasonic pumps and acoustic forces); electrical or magnetic principles (e.g. electroosmotic flow, electrokinetic pumps, ferrofluidic plugs, electrohydrodynamic pumps, attraction or repulsion using magnetic forces and magnetohydrodynamic pumps); thermodynamic principles (e.g. gas bubble generation/phase-change-induced volume expansion); other kinds of surface-wetting principles (e.g. electrowetting, and optoelectrowetting, as well as chemically, thermally, structurally and radioactively induced surface-tension gradients); gravity; surface tension (e.g., capillary action); electrostatic forces (e.g., electroosmotic flow); centrifugal flow (substrate disposed on a compact disc and rotated); magnetic forces (e.g., oscillating ions causes flow); magnetohydrodynamic forces; and vacuum or pressure differential. In certain embodiments, combinations of two or more of the foregoing techniques may be employed to conduct a droplet operation in a droplet actuator of the invention. Similarly, one or more of the foregoing may be used to deliver liquid into a droplet operations gap, e.g., from a reservoir in another device or from an external reservoir of the droplet actuator (e.g., a reservoir associated with a droplet actuator substrate and a flow path from the reservoir into the droplet operations gap). Droplet operations surfaces of certain droplet actuators of the invention may be made from hydrophobic materials or may be coated or treated to make them hydrophobic. For example, in some cases some portion or all of the droplet operations surfaces may be derivatized with low surface-energy materials or chemistries, e.g., by deposition or using in situ synthesis using compounds such as poly- or per-fluorinated compounds in solution or polymerizable monomers. Examples include TEFLON® AF (available from DuPont, Wilmington, DE), members of the cytop family of materials, coatings in the FLUOROPEL® family of hydrophobic and superhydrophobic coatings (available from Cytonix Corporation, Beltsville, MD), silane coatings, fluorosilane coatings, hydrophobic phosphonate derivatives (e.g., those sold by Aculon, Inc), and NOVEC™ electronic coatings (available from 3M Company, St. Paul, MN), other fluorinated monomers for plasma-enhanced chemical vapor deposition (PECVD), and organosiloxane (e.g., SiOC) for PECVD. In some cases, the droplet operations surface may include a hydrophobic coating having a thickness ranging from about 10 nm to about 1,000 nm. Moreover, in some embodiments, the top substrate of the droplet actuator includes an electrically conducting organic polymer, which is then coated with a hydrophobic coating or otherwise treated to make the droplet operations surface hydrophobic. For example, the electrically conducting organic polymer that is deposited onto a plastic substrate may be poly(3,4-ethylenedioxythiophene) poly(styrenesulfonate) (PEDOT:PSS). Other examples of electrically conducting organic polymers and alternative conductive layers are described in Pollack et al., International Patent Application No. PCT/US2010/040705, entitled “Droplet Actuator Devices and Methods,” the entire disclosure of which is incorporated herein by reference. One or both substrates may be fabricated using a printed circuit board (PCB), glass, indium tin oxide (ITO)-coated glass, and/or semiconductor materials as the substrate. When the substrate is ITO-coated glass, the ITO coating is preferably a thickness in the range of about 20 to about 200 nm, preferably about 50 to about 150 nm, or about 75 to about 125 nm, or about 100 nm. In some cases, the top and/or bottom substrate includes a PCB substrate that is coated with a dielectric, such as a polyimide dielectric, which may in some cases also be coated or otherwise treated to make the droplet operations surface hydrophobic. When the substrate includes a PCB, the following materials are examples of suitable materials: MITSUI™ BN-300 (available from MITSUI Chemicals America, Inc., San Jose CA); ARLON™ 11N (available from Arlon, Inc, Santa Ana, CA); NELCO® N4000-6 and N5000-30/32 (available from Park Electrochemical Corp., Melville, NY); ISOLA™ FR406 (available from Isola Group, Chandler, AZ), especially IS620; fluoropolymer family (suitable for fluorescence detection since it has low background fluorescence); polyimide family; polyester; polyethylene naphthalate; polycarbonate; polyetheretherketone; liquid crystal polymer; cyclo-olefin copolymer (COC); cyclo-olefin polymer (COP); aramid; THERMOUNT® nonwoven aramid reinforcement (available from DuPont, Wilmington, DE); NOMEX® brand fiber (available from DuPont, Wilmington, DE); and paper. Various materials are also suitable for use as the dielectric component of the substrate. Examples include: vapor deposited dielectric, such as PARYLENE™ C, PARYLENE™ N, PARYLENE™ F and PARYLENE™ HT (for high temperature, ˜300° C.) (available from Parylene Coating Services, Inc., Katy, TX); TEFLON® AF coatings; cytop; soldermasks, such as liquid photoimageable soldermasks (e.g., on PCB) like TAIYO™ PSR4000 series, TAIYO™ PSR and AUS series (available from Taiyo America, Inc. Carson City, NV) (good thermal characteristics for applications involving thermal control), and PROBIMER™ 8165 (good thermal characteristics for applications involving thermal control (available from Huntsman Advanced Materials Americas Inc., Los Angeles, CA); dry film soldermask, such as those in the VACREL® dry film soldermask line (available from DuPont, Wilmington, DE); film dielectrics, such as polyimide film (e.g., KAPTON® polyimide film, available from DuPont, Wilmington, DE), polyethylene, and fluoropolymers (e.g., FEP), polytetrafluoroethylene; polyester; polyethylene naphthalate; cyclo-olefin copolymer (COC); cyclo-olefin polymer (COP); any other PCB substrate material listed above; black matrix resin; polypropylene; and black flexible circuit materials, such as DuPont™ Pyralux® HXC and DuPont™ Kapton® MBC (available from DuPont, Wilmington, DE). Droplet transport voltage and frequency may be selected for performance with reagents used in specific assay protocols. Design parameters may be varied, e.g., number and placement of on-actuator reservoirs, number of independent electrode connections, size (volume) of different reservoirs, placement of magnets/bead washing zones, electrode size, electrode shape, inter-electrode spacing, and gap height (between top and bottom substrates) may be varied for use with specific reagents, protocols, droplet volumes, etc. In some cases, a substrate of the invention may be derivatized with low surface-energy materials or chemistries, e.g., using deposition or in situ synthesis using poly- or per-fluorinated compounds in solution or polymerizable monomers. Examples include TEFLON® AF coatings and FLUOROPEL® coatings for dip or spray coating, other fluorinated monomers for plasma-enhanced chemical vapor deposition (PECVD), and organosiloxane (e.g., SiOC) for PECVD. Additionally, in some cases, some portion or all of the droplet operations surface may be coated with a substance for reducing background noise, such as background fluorescence from a PCB substrate. For example, the noise-reducing coating may include a black matrix resin, such as the black matrix resins available from Toray industries, Inc., Japan. Electrodes of a droplet actuator are typically controlled by a controller or a processor, which is itself provided as part of a system, which may include processing functions as well as data and software storage and input and output capabilities. Reagents may be provided on the droplet actuator in the droplet operations gap or in a reservoir fluidly coupled to the droplet operations gap. The reagents may be in liquid form, e.g., droplets, or they may be provided in a reconstitutable form in the droplet operations gap or in a reservoir fluidly coupled to the droplet operations gap. Reconstitutable reagents may typically be combined with liquids for reconstitution. An example of reconstitutable reagents suitable for use with the invention includes those described in Meathrel, et al., U.S. Pat. No. 7,727,466, entitled “Disintegratable films for diagnostic devices,” granted on Jun. 1, 2010.

“Droplet operation” means any manipulation of a droplet on a droplet actuator. A droplet operation may, for example, include: loading a droplet into the droplet actuator; dispensing one or more droplets from a source droplet; splitting, separating or dividing a droplet into two or more droplets; transporting a droplet from one location to another in any direction; merging or combining two or more droplets into a single droplet; diluting a droplet; mixing a droplet; agitating a droplet; deforming a droplet; retaining a droplet in position; incubating a droplet; heating a droplet; vaporizing a droplet; cooling a droplet; disposing of a droplet; transporting a droplet out of a droplet actuator; other droplet operations described herein; and/or any combination of the foregoing. The terms “merge,” “merging,” “combine,” “combining” and the like are used to describe the creation of one droplet from two or more droplets. It should be understood that when such a term is used in reference to two or more droplets, any combination of droplet operations that are sufficient to result in the combination of the two or more droplets into one droplet may be used. For example, “merging droplet A with droplet B,” can be achieved by transporting droplet A into contact with a stationary droplet B, transporting droplet B into contact with a stationary droplet A, or transporting droplets A and B into contact with each other. The terms “splitting,” “separating” and “dividing” are not intended to imply any particular outcome with respect to volume of the resulting droplets (i.e., the volume of the resulting droplets can be the same or different) or number of resulting droplets (the number of resulting droplets may be 2, 3, 4, 5 or more). The term “mixing” refers to droplet operations which result in more homogenous distribution of one or more components within a droplet. Examples of “loading” droplet operations include microdialysis loading, pressure assisted loading, robotic loading, passive loading, and pipette loading. Droplet operations may be electrode-mediated. In some cases, droplet operations are further facilitated by the use of hydrophilic and/or hydrophobic regions on surfaces and/or by physical obstacles. For examples of droplet operations, see the patents and patent applications cited above under the definition of “droplet actuator.” Impedance and/or capacitance sensing and/or imaging techniques may sometimes be used to determine or confirm the outcome of a droplet operation. Examples of such techniques are described in Sturmer et al., International Patent Pub. No. WO/2008/101194, entitled “Capacitance Detection in a Droplet Actuator,” published on Aug. 21, 2008, the entire disclosure of which is incorporated herein by reference. Generally speaking, the sensing or imaging techniques may be used to confirm the presence or absence of a droplet at a specific electrode. For example, the presence of a dispensed droplet at the destination electrode following a droplet dispensing operation confirms that the droplet dispensing operation was effective. Similarly, the presence of a droplet at a detection spot at an appropriate step in an assay protocol may confirm that a previous set of droplet operations has successfully produced a droplet for detection. Droplet transport time can be quite fast. For example, in various embodiments, transport of a droplet from one electrode to the next may be completed within about 1 sec, or about 0.1 sec, or about 0.01 sec, or about 0.001 sec. In one embodiment, the electrode is operated in AC mode but is switched to DC mode for imaging. It is helpful for conducting droplet operations for the footprint area of droplet to be similar to or larger than the electrowetting area; in other words, 1×-, 2×-3×-droplets are usefully controlled and/or operated using 1, 2, and 3 electrodes, respectively. If the droplet footprint is greater than number of electrodes available for conducting a droplet operation at a given time, the difference between the droplet size and the number of electrodes should typically not be greater than 1; in other words, a 2× droplet is usefully controlled using 1 electrode and a 3× droplet is usefully controlled using 2 electrodes. When droplets include beads, it is useful for droplet size to be equal to the number of electrodes controlling the droplet, e.g., transporting the droplet.

“Filler fluid” means a fluid associated with a droplet operations substrate of a droplet actuator, which fluid is sufficiently immiscible with a droplet phase to render the droplet phase subject to electrode-mediated droplet operations. For example, the droplet operations gap of a droplet actuator is typically filled with a filler fluid. The filler fluid may, for example, be or include a low-viscosity oil, such as silicone oil or hexadecane filler fluid. The filler fluid may be or include a halogenated oil, such as a fluorinated or perfluorinated oil. The filler fluid may fill the entire gap of the droplet actuator or may coat one or more surfaces of the droplet actuator. Filler fluids may be selected to improve droplet operations and/or reduce loss of reagent or target substances from droplets, improve formation of microdroplets, reduce cross contamination between droplets, reduce contamination of droplet actuator surfaces, reduce degradation of droplet actuator materials, etc. For example, filler fluids may be selected for compatibility with droplet actuator materials. As an example, fluorinated filler fluids may be usefully employed with fluorinated surface coatings. Fluorinated filler fluids are useful to reduce loss of lipophilic compounds, such as umbelliferone substrates like 6-hexadecanoylamido-4-methylumbelliferone substrates (e.g., for use in Krabbe, Niemann-Pick, or other assays); other umbelliferone substrates are described in U.S. Patent Pub. No. 20110118132, published on May 19, 2011, the entire disclosure of which is incorporated herein by reference. Examples of suitable fluorinated oils include those in the Galden line, such as Galden HT170 (bp=170° C., viscosity=1.8 cSt, density=1.77), Galden HT200 (bp=200 C, viscosity=2.4 cSt, d=1.79), Galden HT230 (bp=230 C, viscosity=4.4 cSt, d=1.82) (all from Solvay Solexis); those in the Novec line, such as Novec 7500 (bp=128 C, viscosity=0.8 cSt, d=1.61), Fluorinert FC-40 (bp=155° C., viscosity=1.8 cSt, d=1.85), Fluorinert FC-43 (bp=174° C., viscosity=2.5 cSt, d=1.86) (both from 3M). In general, selection of perfluorinated filler fluids is based on kinematic viscosity (<7 cSt is preferred, but not required), and on boiling point (>150° C. is preferred, but not required, for use in DNA/RNA-based applications (PCR, etc.)). Filler fluids may, for example, be doped with surfactants or other additives. For example, additives may be selected to improve droplet operations and/or reduce loss of reagent or target substances from droplets, formation of microdroplets, cross contamination between droplets, contamination of droplet actuator surfaces, degradation of droplet actuator materials, etc. Composition of the filler fluid, including surfactant doping, may be selected for performance with reagents used in the specific assay protocols and effective interaction or non-interaction with droplet actuator materials. Examples of filler fluids and filler fluid formulations suitable for use with the invention are provided in Srinivasan et al, International Patent Pub. Nos. WO/2010/027894, entitled “Droplet Actuators, Modified Fluids and Methods,” published on Mar. 11, 2010, and WO/2009/021173, entitled “Use of Additives for Enhancing Droplet Operations,” published on Feb. 12, 2009; Sista et al., International Patent Pub. No. WO/2008/098236, entitled “Droplet Actuator Devices and Methods Employing Magnetic Beads,” published on Aug. 14, 2008; and Monroe et al., U.S. Patent Publication No. 20080283414, entitled “Electrowetting Devices,” filed on May 17, 2007; the entire disclosures of which are incorporated herein by reference, as well as the other patents and patent applications cited herein. Fluorinated oils may in some cases be doped with fluorinated surfactants, e.g., Zonyl FSO-100 (Sigma-Aldrich) and/or others.

“Reservoir” means an enclosure or partial enclosure configured for holding, storing, or supplying liquid. A droplet actuator system of the invention may include on-cartridge reservoirs and/or off-cartridge reservoirs. On-cartridge reservoirs may be (1) on-actuator reservoirs, which are reservoirs in the droplet operations gap or on the droplet operations surface; (2) off-actuator reservoirs, which are reservoirs on the droplet actuator cartridge, but outside the droplet operations gap, and not in contact with the droplet operations surface; or (3) hybrid reservoirs which have on-actuator regions and off-actuator regions. An example of an off-actuator reservoir is a reservoir in the top substrate. An off-actuator reservoir is typically in fluid communication with an opening or flow path arranged for flowing liquid from the off-actuator reservoir into the droplet operations gap, such as into an on-actuator reservoir. An off-cartridge reservoir may be a reservoir that is not part of the droplet actuator cartridge at all, but which flows liquid to some portion of the droplet actuator cartridge. For example, an off-cartridge reservoir may be part of a system or docking station to which the droplet actuator cartridge is coupled during operation. Similarly, an off-cartridge reservoir may be a reagent storage container or syringe which is used to force fluid into an on-cartridge reservoir or into a droplet operations gap. A system using an off-cartridge reservoir will typically include a fluid passage means whereby liquid may be transferred from the off-cartridge reservoir into an on-cartridge reservoir or into a droplet operations gap.

“Washing” with respect to washing a surface, such as a hydrophilic surface, means reducing the amount and/or concentration of one or more substances in contact with the surface or exposed to the surface from a droplet in contact with the surface. The reduction in the amount and/or concentration of the substance may be partial, substantially complete, or even complete. The substance may be any of a wide variety of substances; examples include target substances for further analysis, and unwanted substances, such as components of a sample, contaminants, and/or excess reagent or buffer.

The terms “top,” “bottom,” “over,” “under,” and “on” are used throughout the description with reference to the relative positions of components of the droplet actuator, such as relative positions of top and bottom substrates of the droplet actuator. It will be appreciated that in many cases the droplet actuator is functional regardless of its orientation in space.

When a liquid in any form (e.g., a droplet or a continuous body, whether moving or stationary) is described as being “on”, “at”, or “over” an electrode, array, matrix or surface, such liquid could be either in direct contact with the electrode/array/matrix/surface, or could be in contact with one or more layers or films that are interposed between the liquid and the electrode/array/matrix/surface. In one example, filler fluid can be considered as a dynamic film between such liquid and the electrode/array/matrix/surface.

When a droplet is described as being “on” or “loaded on” a droplet actuator, it should be understood that the droplet is arranged on the droplet actuator in a manner which facilitates using the droplet actuator to conduct one or more droplet operations on the droplet, the droplet is arranged on the droplet actuator in a manner which facilitates sensing of a property of or a signal from the droplet, and/or the droplet has been subjected to a droplet operation on the droplet actuator.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

In some embodiments, the presently disclosed subject matter provides a microfluidics system, instrument, and cartridge including multi-sided or multi-outlet digital microfluidics (DMF) dispensing and method. For example, the presently disclosed microfluidics system, instrument, and cartridge provides a multi-sided DMF dispenser that can support high-throughput DMF-based processing, such as, but not limited to, high-throughput DMF-based COVID-19 assays.

In some embodiments, the presently disclosed microfluidics system, instrument, and cartridge including multi-sided or multi-outlet DMF dispensing and method can include dual-sided (or two-sided) dispensers, triple-sided (or three-sided) dispensers, and/or quad-sided (or four-sided) dispensers.

In some embodiments, the presently disclosed microfluidics system, instrument, and cartridge including multi-sided or multi-outlet DMF dispensing and method can include a dual-sided (or two-sided) dispenser and wherein the dual-sided dispenser can include, for example, a line of multiple (e.g., three) dispenser electrodes, an arrangement of droplets operations electrodes leading away from one end of the line of dispenser electrodes to provide an first outlet, and an arrangement of droplets operations electrodes leading away from the other end of the line of dispenser electrodes to provide a second outlet.

In some embodiments, the presently disclosed microfluidics system, instrument, and cartridge including multi-sided or multi-outlet DMF dispensing and method can include a triple-sided (or three-sided) dispenser and wherein the triple-sided dispenser can include, for example, a line of multiple (e.g., three) dispenser electrodes, an arrangement of droplets operations electrodes leading away from one end of the line of dispenser electrodes to provide an first outlet, an arrangement of droplets operations electrodes leading away from the other end of the line of dispenser electrodes to provide a second outlet, and an arrangement of droplets operations electrodes leading away from one side of the line of dispenser electrodes to provide a third outlet.

In some embodiments, the presently disclosed microfluidics system, instrument, and cartridge including multi-sided or multi-outlet DMF dispensing and method can include a quad-sided (or four-sided) dispenser and wherein the quad-sided dispenser can include, for example, a line of multiple (e.g., three) dispenser electrodes, an arrangement of droplets operations electrodes leading away from one end of the line of dispenser electrodes to provide an first outlet, an arrangement of droplets operations electrodes leading away from the other end of the line of dispenser electrodes to provide a second outlet, an arrangement of droplets operations electrodes leading away from one side of the line of dispenser electrodes to provide a third outlet, and an arrangement of droplets operations electrodes leading away from the other side of the line of dispenser electrodes to provide a fourth outlet.

In some embodiments, the presently disclosed microfluidics system, instrument, and cartridge including multi-sided or multi-outlet DMF dispensing and method can include an array or matrix of multi-sided dispensers, such as dual-sided dispensers, and wherein the array or matrix can include rows and columns of multi-sided dispensers and wherein the array or matrix may be scalable to any number of multi-sided dispensers.

In some embodiments, the presently disclosed microfluidics system, instrument, and cartridge including multi-sided or multi-outlet DMF dispensing and method can include an array or matrix of multi-sided or multi-outlet dispensers, such as dual-sided dispensers, including rows and columns of multi-sided dispensers and wherein, for example, each row of multi-sided dispensers in the array or matrix may be designated a droplet operations station.

In some embodiments, in the presently disclosed microfluidics system, instrument, and cartridge including multi-sided or multi-outlet DMF dispensing and method, individual multi-sided dispensers, such as dual-sided dispensers, can be used to do both right-side and left-side dispensing to supply two different flow paths.

In some embodiments, in the presently disclosed microfluidics system, instrument, and cartridge including multi-sided or multi-outlet DMF dispensing and method, the presence of multi-sided dispensers, such as dual-sided dispensers, can allow a smaller number of dispensers to be present in a microfluidics cartridge for a certain assay as compared with conventional microfluidics cartridges including conventional dispensers (e.g., one-sided dispensers). Accordingly, the design of the microfluidics cartridge including multi-sided or multi-outlet dispensers may be less complex, less costly, and requiring less dispensing real estate as compared with conventional microfluidics cartridges including conventional dispensers.

In some embodiments, in the presently disclosed microfluidics system, instrument, and cartridge including multi-sided DMF dispensing and method, the presence of multi-sided dispensers, such as dual-sided dispensers, can provide an easier way to multiplex as compared with conventional microfluidics cartridges including conventional dispensers.

In some embodiments, in the presently disclosed microfluidics system, instrument, and cartridge including multi-sided or multi-outlet DMF dispensing and method, the presence of an array or matrix of multi-sided dispensers, such as dual-sided dispensers, can provide an efficient way to supply multiple flow paths simultaneously in an assay.

In some embodiments, in the presently disclosed microfluidics system, instrument, and cartridge including multi-sided or multi-outlet DMF dispensing and method, the presence of an array or matrix of multi-sided dispensers, such as dual-sided dispensers, allows each droplet operations station to be used to facilitate interactions between multiple types of liquids.

In some embodiments, in the presently disclosed microfluidics system, instrument, and cartridge including multi-sided or multi-outlet DMF dispensing and method, the presence of an array or matrix of multi-sided or multi-outlet dispensers, such as dual-sided dispensers, allows multiple multi-sided dispensers at any droplet operations station to act in parallel.

In some embodiments, in the presently disclosed microfluidics system, instrument, and cartridge including multi-sided or multi-outlet DMF dispensing and method, the presence of an array or matrix of multi-sided or multi-outlet dispensers, such as dual-sided dispensers, allows the transport distance between operations to be minimized (i.e., by minimizing the number of droplet operations electrodes) compared with conventional electrode configurations.

Further, a method of using a multi-sided dispenser, such as a dual-sided dispenser, is provided.

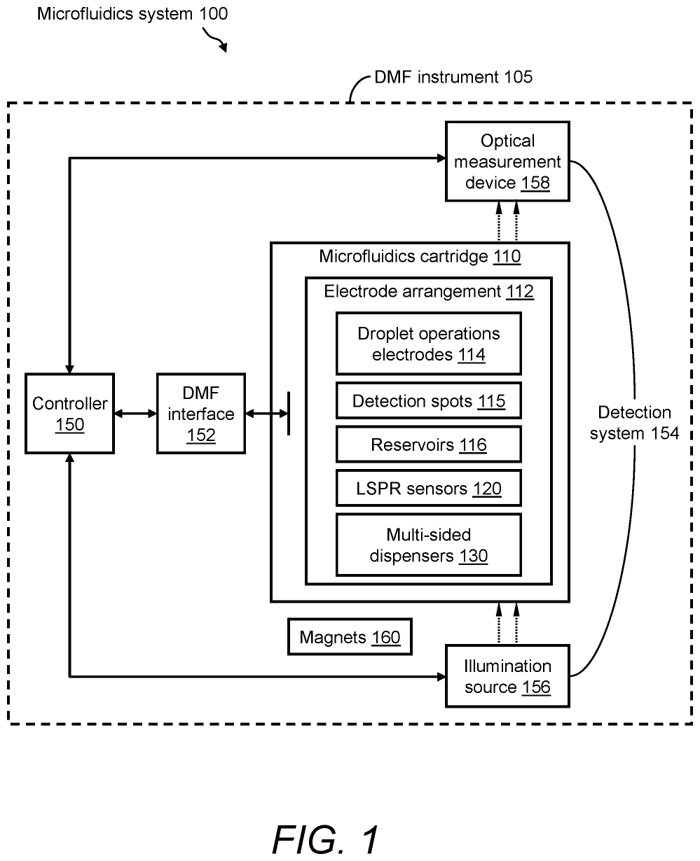

Referring now to FIG. 1 is a block diagram of an example of the presently disclosed microfluidics system 100 including a DMF cartridge further including multi-sided or multi-outlet dispensers. In one example, the multi-sided DMF dispensers can be dual-sided DMF dispensers for supporting dual-dispensing processes. In another example, the multi-sided DMF dispensers can be triple-sided DMF dispensers for supporting triple-dispensing processes. In another example, the multi-sided DMF dispensers can be quad-sided DMF dispensers for supporting quad-dispensing processes.

For example, the presently disclosed microfluidics system 100 can include a microfluidics cartridge 110 that can support automated processes to manipulate, process and/or analyze biological materials. Microfluidics cartridge 110 can be, for example, any DMF device or cartridge, droplet actuator, and the like that can be used to facilitate DMF capabilities generally for fluidic actuation. Microfluidics cartridge 110 of microfluidics system 100 can be provided, for example, as a disposable and/or reusable DMF device or cartridge. Generally, DMF devices (e.g., microfluidics cartridge 110) consist of two substrates separated by a gap that forms a chamber in which the droplet operations are performed. In one example, microfluidics cartridge 110 can include a printed circuit board (PCB) substrate and a glass or plastic substrate separated by a gap.

DMF capabilities can include, but are not limited to, transporting, merging, mixing, splitting, dispensing, diluting, agitating, deforming (shaping), and other types of droplet operations. Applications of these DMF capabilities can include, for example, sample preparation and waste removal. Generally, microfluidics system 100 and microfluidics cartridge 110 can be used to process biological materials. However, particular to microfluidics system 100, in one example the DMF capabilities of microfluidics cartridge 110 can be used to perform biological assays, such as, but not limited to, COVID-19 assays.

For example, microfluidics cartridge 110 of microfluidics system 100 can include an electrode arrangement 112 that can include, but is not limited to, any arrangements (e.g., lines, paths, arrays) of droplet operations electrodes 114 (i.e., electrowetting electrodes) that can be used to fluidly connect any arrangements of one or more reservoirs 116, one or more localized surface plasmon resonance (LSPR) sensors 120, and one or more multi-sided or multi-outlet dispensers 130.

Further, certain droplet operations electrodes 114 can be designated as detection spots 115.

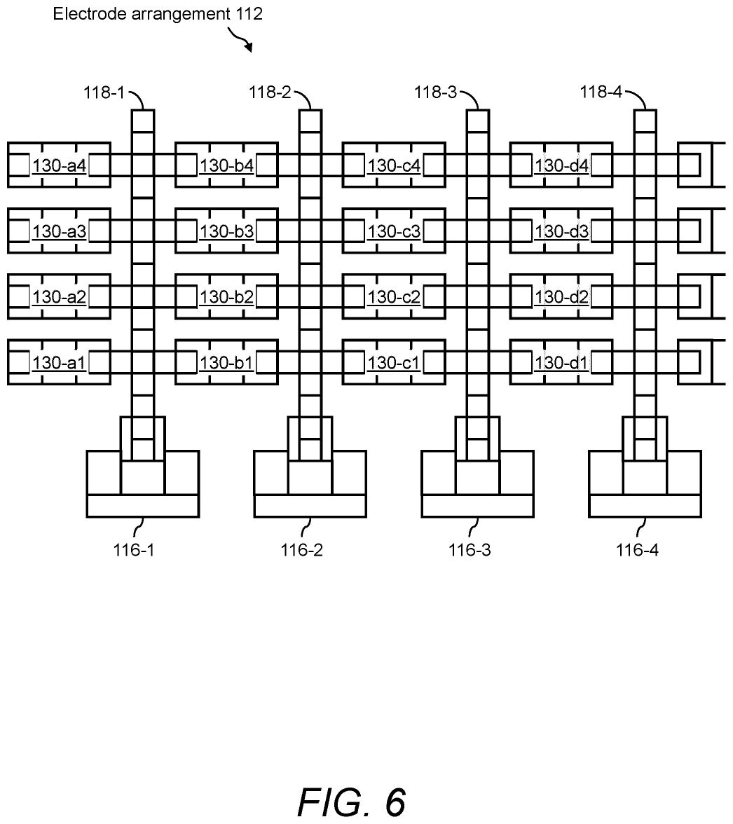

Reservoirs 116 can be any fluid sources integrated with or otherwise fluidly coupled to microfluidics cartridge 110. Reservoirs 116 can include any number and/or arrangements of, for example, on-cartridge reservoirs, off-cartridge reservoirs, blister packs, fluid ports, and the like, and any combinations thereof. Reservoirs 116 can be used to manage any liquids, such as reagents, buffers, sample volumes, and the like, needed to support any processes of microfluidics cartridge 110. On-cartridge reservoirs 116, for example, can be formed of particular arrangements of droplet operations electrodes 114, such as shown in FIG. 6 through FIG. 32.

LSPR sensors 120 can be provided in relation to certain droplet operations electrodes 114. Generally, LSPR sensing can be used to determine the chemical affinity between a pair of molecules or bodies, such as proteins, antigens, antibodies, drugs, and the like. An example of LSPR sensing is described with reference to U.S. Pat. No. 9,322,823, entitled “Method and Apparatus for Chemical Detection,” issued on Apr. 26, 2016; the entire disclosure of which is incorporated herein by reference. The '823 patent describes a sensing apparatus comprising, at least one LSPR light source, at least one detector, and at least one sensor for LSPR detection of a target chemical. The sensor comprises a substantially transparent, porous membrane having nanoparticles immobilized on the surface of its pores, the nanoparticles being functionalized with one or more capture molecules.

LSPR sensors 120 can be used to determine the K_{D} value, the k_{ON} value, and/or the k_{OFF} value of the analyte sample with an immobilized ligand, wherein the K_{D} value is a quantitative measurement of analyte affinity, the k_{ON} value indicates the kinetic ON-rate of the analyte sample, and the k_{OFF} value indicates the kinetic OFF-rate of the analyte sample. Accordingly, LSPR sensors 120 can be used for (1) detecting, for example, certain molecules (e.g., target analytes) and/or chemicals in the sample, and/or (2) for analysis of analytes; that is, for measuring binding events in real time to extract ON-rate information, OFF-rate information, and/or affinity information. LSPR sensors 120 can be based, for example, on fixed LSPR sensing and/or any in-solution LSPR sensing processes.

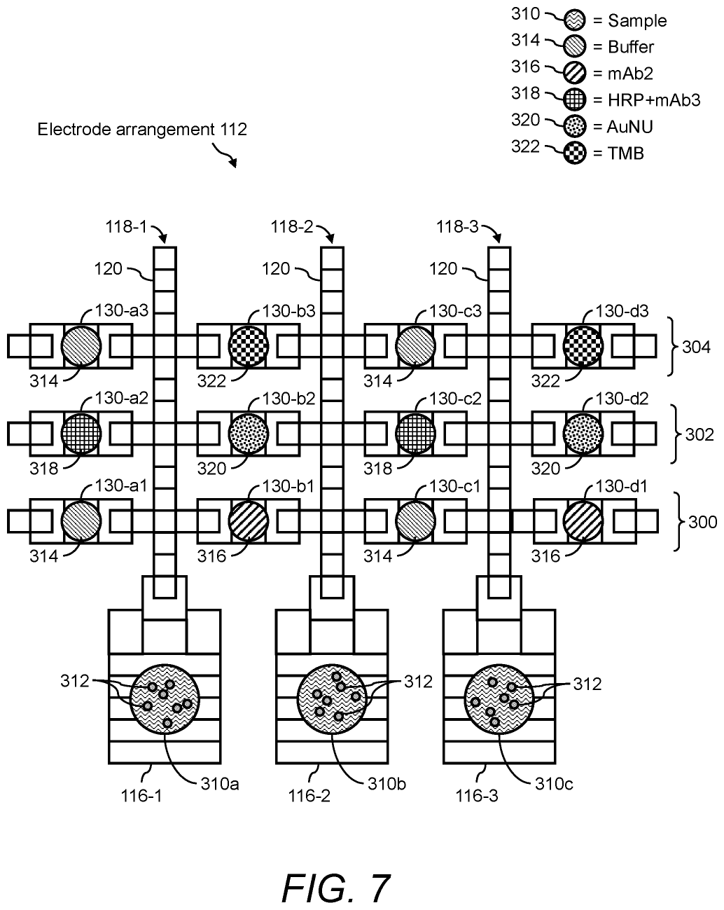

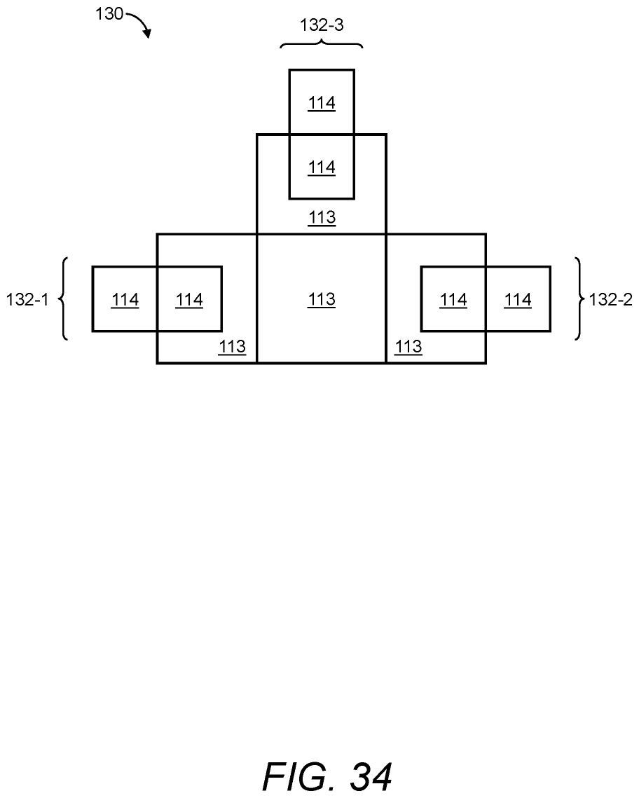

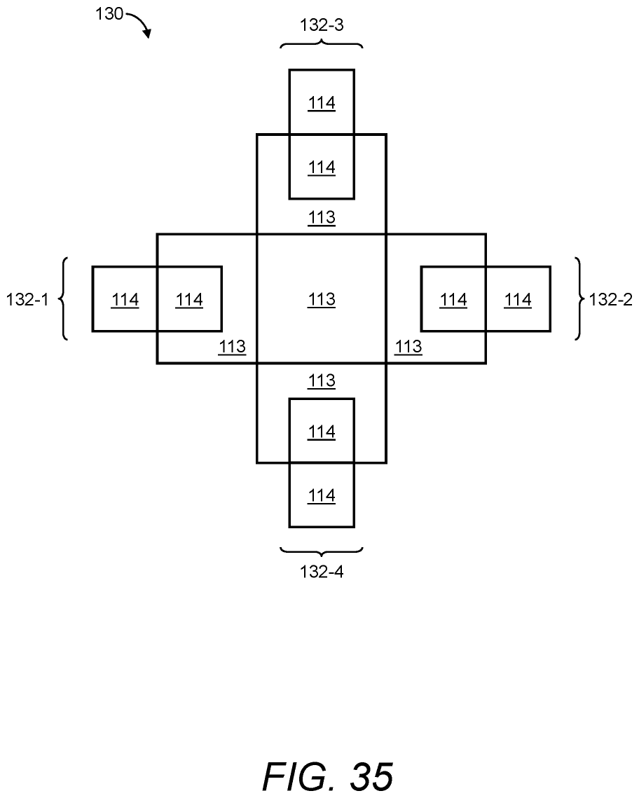

In microfluidics system 100, multi-sided or multi-outlet dispensers 130 can be designed to hold a volume of liquid and with the capability to dispense droplets from multiple outlets independently and/or simultaneously. In one example, multi-sided dispensers 130 can be dual-sided dispensers 130 for supporting dual-dispensing processes (see FIG. 7 through FIG. 32). In another example, multi-sided or multi-outlet dispensers 130 can be triple-sided dispensers 130 (see FIG. 34) for supporting triple-dispensing processes. In another example, multi-sided dispensers 130 (see FIG. 35) can be quad-sided dispensers 130 for supporting quad-dispensing processes.

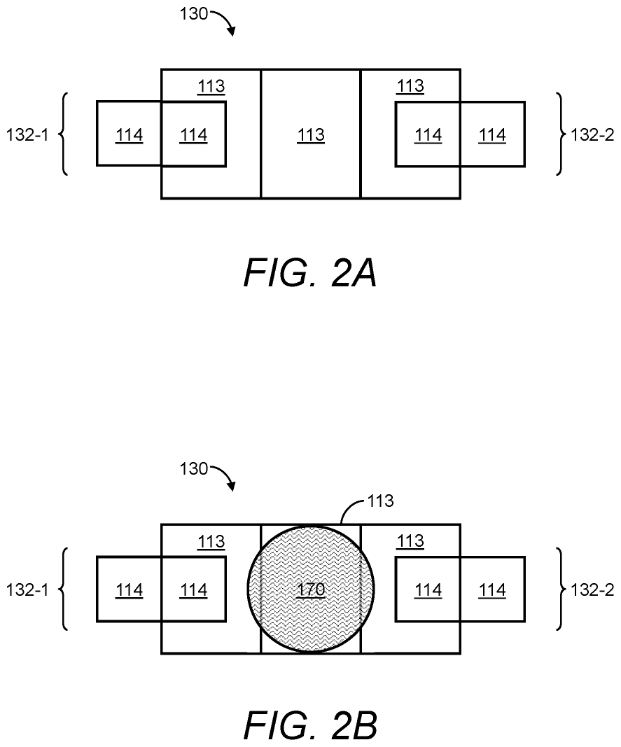

Like on-cartridge reservoirs 116, multi-sided dispensers 130 can be formed of particular arrangements of droplet operations electrodes 114. Examples of dual-sided or dual-outlet dispensers 130 are shown and described hereinbelow with reference to FIG. 2 through FIG. 3B and FIG. 6 through FIG. 32. In this example, each dual-sided dispenser 130 can be designed to hold a volume of liquid and with the capability to dispense droplets from a first side or outlet independently, from a second side or outlet independently, or from both the first and second side or outlet simultaneously. An example of a triple-sided dispenser 130 for supporting triple-dispensing processes is shown in FIG. 34. An example of a quad-sided dispenser 130 for supporting quad-dispensing processes is shown in FIG. 35.

Certain benefits of multi-sided or multi-outlet dispensers 130 (e.g., dual-sided dispensers 130) can include, but are not limited to, (1) the ability to dispense from multiple outlets to supply multiple different droplet operations flow paths; (2) providing an efficient way to supply multiple droplet operations flow paths simultaneously in an assay; (3) the ability to facilitate interactions between multiple types of liquids; (4) the ability for multiple multi-sided dispensers to act in parallel; (5) allowing the transport distance between operations to be minimized (i.e., by minimizing the number of droplet operations electrodes) compared with conventional electrode configurations, (6) providing an easier way to multiplex as compared with conventional microfluidics cartridges including conventional dispensers; and (7) allowing a smaller number of dispensers to be present in a microfluidics cartridge for a certain assay as compared with conventional microfluidics cartridges including conventional dispensers (e.g., one-sided dispensers). An example of using multi-sided dispensers 130 (e.g., dual-sided dispensers 130) to perform an assay is shown and described hereinbelow with reference to FIG. 7 through FIG. 32.

Microfluidics system 100 may further include a controller 150, a DMF interface 152, a detection system 154, and one or more magnets 160. Controller 150 may be electrically coupled to the various hardware components of microfluidics system 100, such as to microfluidics cartridge 110, detection system 154, and magnets 160. In particular, controller 150 may be electrically coupled to microfluidics cartridge 110 via DMF interface 152, wherein DMF interface 152 may be, for example, a pluggable interface for connecting mechanically and electrically to microfluidics cartridge 110.

Detection system 154 can be any detection mechanism that can be used to accurately determine the presence or absence of a defined analyte and/or target component in different materials and to sensitively quantify the amount of analyte and/or target components present in a sample. Detection system 154 can be, for example, an optical measurement system that includes an illumination source 156 and an optical measurement device 158. For example, detection system 154 can be a fluorimeter that provides both excitation and detection. In this example, illumination source 156 and optical measurement device 158 can be arranged with respect to microfluidics cartridge 110. Further, detection spots 115 of microfluidics cartridge 110 can be any droplet operations electrodes 114 designated for detection operations via detection system 154.

The illumination source 156 can be, for example, a light source for the visible range (400-800 nm), such as, but not limited to, a white light-emitting diode (LED), a halogen bulb, an arc lamp, an incandescent lamp, lasers, and the like. Illumination source 156 is not limited to a white light source. Illumination source 156 can be any color light that is useful in microfluidics system 100. Optical measurement device 158 can be used to obtain light intensity readings. Optical measurement device 158 can be, for example, a charge coupled device, a photodetector, a spectrometer, a photodiode array, or any combinations thereof. Further, microfluidics system 100 is not limited to one detection system 154 only (e.g., one illumination source 156 and one optical measurement device 158 only). Microfluidics system 100 can include multiple detection systems 154 (e.g., multiple illumination sources 156 and/or multiple optical measurement devices 158) to support multiple detection spots 115.

Together, microfluidics cartridge 110, controller 150, DMF interface 152, detection system 154 (e.g., illumination source 156 and optical measurement device 158), and magnets 160 may comprise a DMF instrument 105. Optionally, DMF instrument 105 can be connected to a networked computer (not shown), such as any centralized server or cloud-based server.

Controller 150 may, for example, be a general-purpose computer, special purpose computer, personal computer, microprocessor, tablet, mobile device, or other programmable data processing apparatus. Controller 150 may provide processing capabilities, such as storing, interpreting, and/or executing software instructions, as well as controlling the overall operations of microfluidics system 100. The software instructions may comprise machine readable code stored in non-transitory memory that is accessible by the controller 150 for the execution of the instructions. Controller 150 may be configured and programmed to control data and/or power aspects of microfluidics system 100. Further, data storage (not shown) may be built into or provided separate from controller 150. Communication between Controller 150 and various components of DMF instrument 105 may be via wired connections, or wireless connections, such as WiFi or radio frequency, among others.

Generally, controller 150 may be used to manage any functions of microfluidics system 100. For example, controller 150 may be used to manage the operations of, detection system 154 (e.g., illumination source 156 and optical measurement device 158), magnets 160, and any other instrumentation (not shown) in relation to microfluidics cartridge 110. Magnets 160 may be, for example, permanent magnets and/or electromagnets. In the case of electromagnets, controller 150 may be used to control the electromagnets 160. Further, with respect to microfluidics cartridge 110, controller 150 may control droplet manipulation by activating/deactivating electrodes.

In other embodiments of microfluidics system 100, the functions of controller 150, detection system 154 (e.g., illumination source 156 and optical measurement device 158), magnets 160, and/or any other instrumentation can be integrated directly into microfluidics cartridge 110 rather than provided separately from microfluidics cartridge 110.

Referring now to FIG. 2A and FIG. 2B is plan views of an example of a dual-sided dispenser 130, which is one example of multi-sided or multi-outlet dispensers 130 of microfluidics system 100 shown in FIG. 1. For example, dual-sided dispenser 130 can include a line of dispenser electrodes 113 with an arrangement of droplet operations electrodes 114 leading away from both ends of the line. In one example, dual-sided dispenser 130 can include a line of three dispenser electrodes 113. Further, an arrangement of droplet operations electrodes 114 can be provided leading away from one end of the line of three dispenser electrodes 113 to provide an outlet 132-1. Further, another arrangement of droplet operations electrodes 114 can be provided leading away from the other end of the line of three dispenser electrodes 113 to provide an outlet 132-2. FIG. 2A shows dual-sided dispenser 130 not loaded with liquid. FIG. 2B shows dual-sided dispenser 130 loaded with, for example, a volume of liquid 170 atop dispenser electrodes 113.

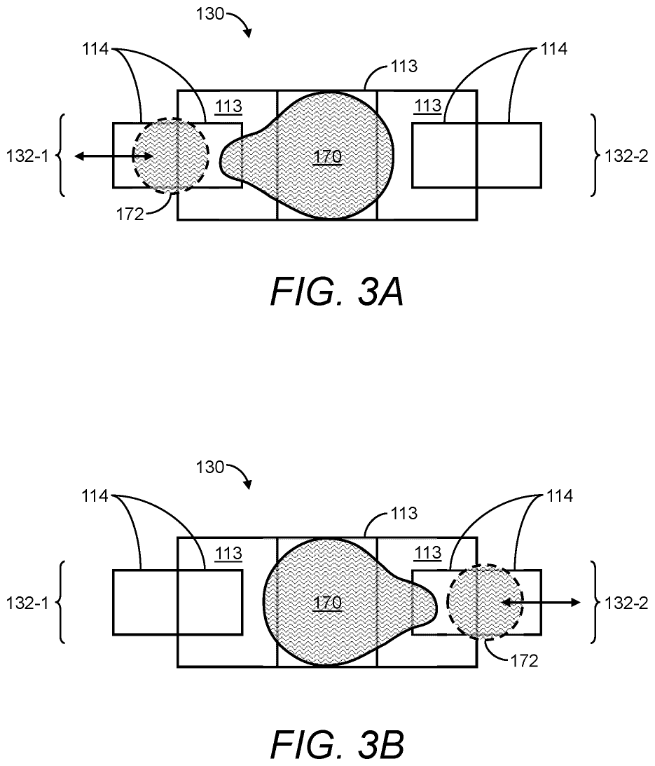

Referring now to FIG. 3A and FIG. 3B are plane views of an example of using dual-sided dispenser 130 shown in FIG. 2A and FIG. 2B. For example, FIG. 3A shows dual-sided dispenser 130 loaded with the volume of liquid 170 and dispensing a droplet 172 via droplet operations from outlet 132-1. For discussion purposes only, dispensing from outlet 132-1 may be called “left-side” dispensing. Next, FIG. 3B shows dual-sided dispenser 130 loaded with the volume of liquid 170 and dispensing a droplet 172 via droplet operations from outlet 132-2. For discussion purposes only, dispensing from outlet 132-1 may be called “right-side” dispensing. Accordingly, FIG. 3A and FIG. 3B show that the outlets 132 of dual-sided dispenser 130 may be operated independently and/or simultaneously.

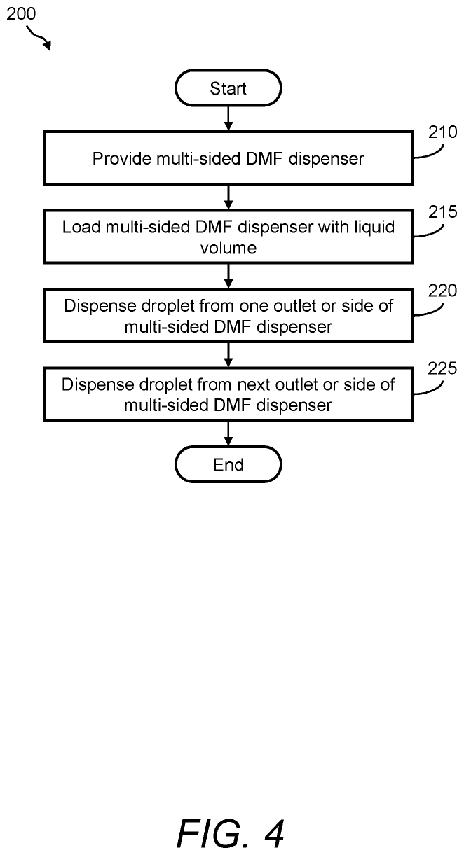

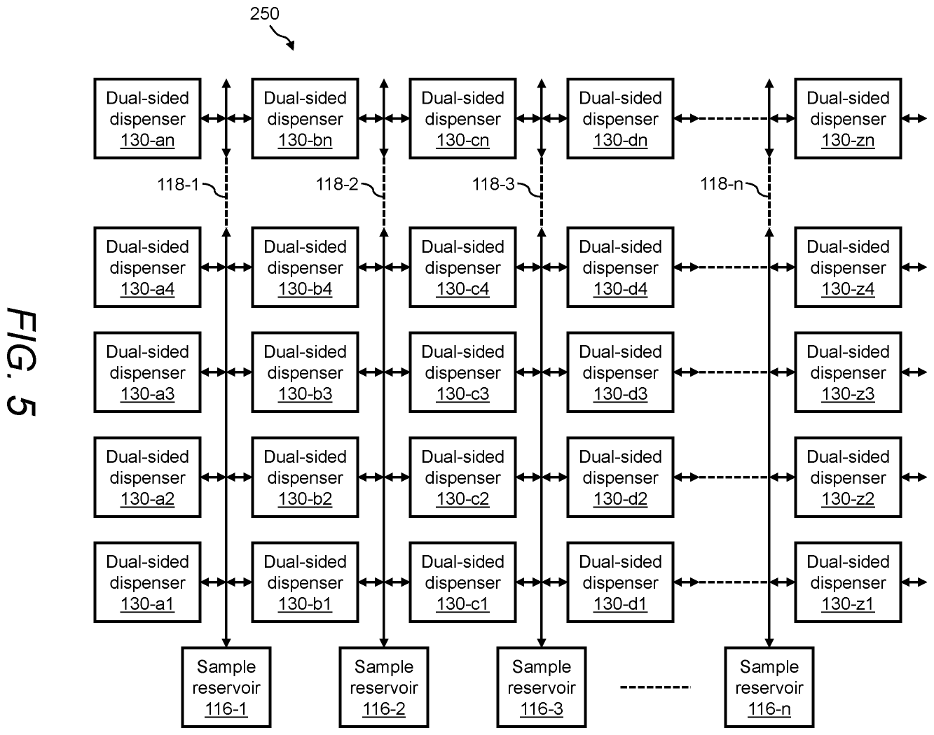

Referring now to FIG. 4 is a flow diagram of an example of a method 200 of using the multi-sided dispensers 130 according to a simplest configuration. Method 200 can include, but is not limited to, the following steps.

At a step 210, a multi-sided DMF dispenser is provided. For example, a multi-sided dispenser 130 can be provided in microfluidics cartridge 110 of microfluidics system 100. In one example, a dual-sided dispenser 130 (see FIG. 2A) can be provided. In another example, a triple-sided dispenser 130 (see FIG. 34) can be provided. In another example, a quad-sided dispenser 130 (see FIG. 35) can be provided.

At a step 215, the multi-sided DMF dispenser is loaded with a liquid volume. For example and referring now to FIG. 2B, dual-sided dispenser 130 can be loaded with a volume of liquid 170.

At a step 220, a droplet is dispensed from one outlet or side of the multi-sided DMF dispenser. For example and referring now to FIG. 3A, droplet 172 can be dispensed via droplet operations from outlet 132-1 of dual-sided dispenser 130.

At a step 225, a droplet is dispensed from the next outlet or side of the multi-sided DMF dispenser. For example and referring now to FIG. 3B, droplet 172 can be dispensed via droplet operations from outlet 132-2 of dual-sided dispenser 130.

Referring now to FIG. 5 is a block diagram of an example of an array or matrix 250 of the dual-sided dispensers 130 shown in FIG. 2A and FIG. 2B. Array or matrix 250 can be, for example, a scalable z×n array or matrix of dual-sided dispensers 130. For example, array or matrix 250 can include rows and columns of dual-sided dispensers 130. In one example, each row of array or matrix 250 can include any number of dual-sided dispensers 130-a through 130-z. Further, each column of array or matrix 250 can include any number of dual-sided dispensers 130-1 through 130-n. Accordingly, any dual-sided dispenser 130-location in array or matrix 250 can be expressed by its row (a-z) and column (1-n) location. For example, the dual-sided dispenser 130 at the first row and first column location is dual-sided dispenser 130-a1, the dual-sided dispenser 130 at the second row and second column location is dual-sided dispenser 130-b2, and so on.

Further, multiple sample reservoirs 116 (e.g., 116-1 to 116-n) and multiple flow paths 118 (e.g., 118-1 to 118-n) can be arranged with respect to array or matrix 250 of dual-sided dispensers 130. Each of the flow paths 118 can be a line of droplet operations electrodes 114. In this example, sample reservoir 116-1 supplies flow path 118-1, sample reservoir 116-2 supplies flow path 118-2, sample reservoir 116-3 supplies flow path 118-3, to sample reservoir 116-n supplies flow path 118-n. Further, in this example, columns “a” and “b” of dual-sided dispensers 130 supply flow path 118-1. Columns “b” and “c” of dual-sided dispensers 130 supply flow path 118-2. Columns “c” and “d” of dual-sided dispensers 130 supply flow path 118-3, and so on. In this configuration, each dual-sided dispenser 130 supplies one flow path 118 on one side and a different flow path 118 on its other side. An example of one physical instantiation of an array or matrix 250 of dual-sided dispensers 130 is shown below in FIG. 6.

By way of example, FIG. 6 shows a plan view of an example of a 4×4 portion of an array or matrix 250 of dual-sided dispensers 130 according to one configuration. In this example, array or matrix 250 can include dual-sided dispensers 130-a1 through 130-d4. Further, in this example, sample reservoir 116-1 supplies flow path 118-1. Flow path 118-1 is fluidly coupled to column “a” of dual-sided dispensers 130 on one side and fluidly coupled to column “b” of dual-sided dispensers 130 on the other side. Likewise, sample reservoir 116-2 supplies flow path 118-2. Flow path 118-2 is fluidly coupled to column “b” of dual-sided dispensers 130 on one side and fluidly coupled to column “c” of dual-sided dispensers 130 on the other side. Likewise, sample reservoir 116-3 supplies flow path 118-3. Flow path 118-3 is fluidly coupled to column “c” of dual-sided dispensers 130 on one side and fluidly coupled to column “d” of dual-sided dispensers 130 on the other side. Likewise, a sample reservoir 116-4 supplies flow path 118-4. Flow path 118-4 is fluidly coupled to column “d” of dual-sided dispensers 130 on one side. In this configuration, for each dual-sided dispenser 130, its outlet 132-1 supplies one flow path 118 and its outlet 132-2 supplies a different flow path 118.

A main benefit of multi-sided dispensers 130, such as dual-sided dispensers 130, can be that for a certain assay they allow a smaller number of dispensers to be present in the microfluidics cartridge as compared with conventional microfluidics cartridges including conventional dispensers (e.g., one-sided dispensers). That is, the design of the microfluidics cartridge including multi-sided dispensers 130 can be less complex, less costly, and requiring less dispensing real estate as compared with conventional microfluidics cartridges including conventional dispensers. Additionally, multi-sided dispensers 130, such as dual-sided dispensers 130, can provide an easier way to multiplex as compared with conventional microfluidics cartridges including conventional dispensers.

Referring now to FIG. 7 through FIG. 32 are plan views of an electrode arrangement 112 including a 3×4 array or matrix 250 of dual-sided dispensers 130 according to another configuration and showing an example of a magnetic bead assay using the dual-sided dispensers 130. In this example, array or matrix 250 can include dual-sided dispensers 130-a1 through 130-d3. Further, sample reservoir 116-1 supplies flow path 118-1, sample reservoir 116-2 supplies flow path 118-2, and sample reservoir 116-3 supplies flow path 118-3.

Further, in this arrangement, right-side dispensing can occur from dual-sided dispensers 130-a1, 130-a2, 130-a3 (i.e., the “a” column) to flow path 118-1. In this example, there is no left-side dispensing from dual-sided dispensers 130-a1, 130-a2, 130-a3. Additionally, left-side dispensing can occur from dual-sided dispensers 130-b1, 130-b2, 130-b3 (i.e., the “b” column) also to flow path 118-1.

Next, in this arrangement, right-side dispensing can occur from dual-sided dispensers 130-b1, 130-b2, 130-b3 (i.e., the “b” column) to flow path 118-2. Additionally, left-side dispensing can occur from dual-sided dispensers 130-c1, 130-c2, 130-c3 (i.e., the “c” column) also to flow path 118-2.

Next, in this arrangement, right-side dispensing can occur from dual-sided dispensers 130-c1, 130-c2, 130-c3 (i.e., the “c” column) to flow path 118-3. Additionally, left-side dispensing can occur from dual-sided dispensers 130-d1, 130-d2, 130-d3 (i.e., the “d” column) also to flow path 118-2. In this example, there is no right-side dispensing from dual-sided dispensers 130-d1, 130-d2, 130-d3.

In this 3×4 array or matrix 250 of dual-sided dispensers 130, it may be said that one side is “capped” with one-sided dispensers 130-a and the other side is “capped” with one-sided dispensers 130-d.

To illustrate the efficiency of dual-sided dispensers 130 for executing an assay, FIG. 7 through FIG. 32 show an example of a magnetic bead assay, which can be, for example, an immunoassay for SARS-CoV-2, which is the causative agent of COVID-19. In this example, the assay can be performed in stages. Accordingly, dual-sided dispensers 130-a1, 130-b1, 130-c1, 130-d1 (i.e., the “1” row) can be called a droplet operations station 300 (i.e., stage one of the assay). Dual-sided dispensers 130-a2, 130-b2, 130-c2, 130-d2 (i.e., the “2” row) can be called a droplet operations station 302 (i.e., stage two of the assay). Dual-sided dispensers 130-a3, 130-b3, 130-c3, 130-d3 (i.e., the “3” row) can be called a droplet operations station 304 (i.e., stage three of the assay).

FIG. 7 shows the assay setup. For example, a sample volume 310 is provided at each sample reservoir 116. Sample volume 310 can be, for example, a subject's saliva to be analyzed for the presence or absence of SARS-CoV-2 (COVID-19). For example, a sample volume 310a is provided at sample reservoir 116-1, a sample volume 310b is provided at sample reservoir 116-2, and a sample volume 310c is provided at sample reservoir 116-3. Further, a quantity of magnetically responsive beads 312 can be provided in suspension in the sample volumes 310. In this example, magnetically responsive beads 312 can be functionalized, for example, with a capture antibody that is specific for a SARS-CoV-2 target antigen.

Next, the dual-sided dispensers 130 can be loaded as follows.
Dual-sided dispensers 130-a1, 130-a3, 130-c1, 130-c3 can be loaded with wash buffer solution (buffer) 314;
Dual-sided dispensers 130-b1, 130-d1 can be loaded with a detection mAb2 antibody (mAb2) 316 that is specific for a SARS-CoV-2 target antigen;
Dual-sided dispensers 130-a2, 130-c2 can be loaded with horseradish peroxidase (HRP) reagent conjugated to a secondary detection mAb3 antibody (HRP+mAb3) 318;
Dual-sided dispensers 130-b2, 130-d2 can be loaded with a gold nano-urchin nanoparticles solution (AuNU) 320; and
Dual-sided dispensers 130-b3, 130-d3 can be loaded with the HRP substrate 3,3′,5,5′-tetramethylbenzidine (TMB) 322.

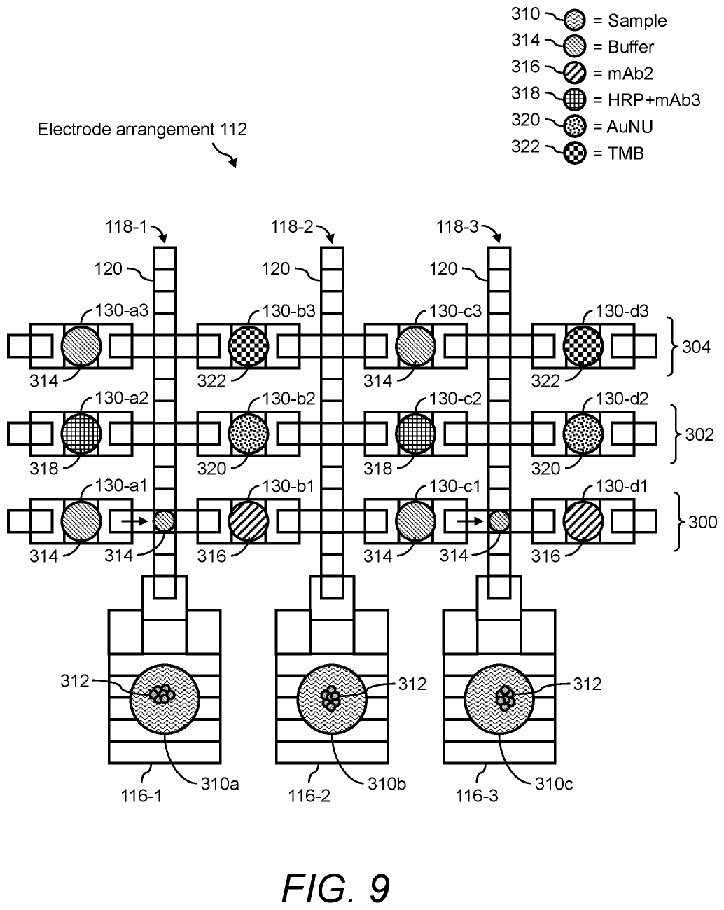

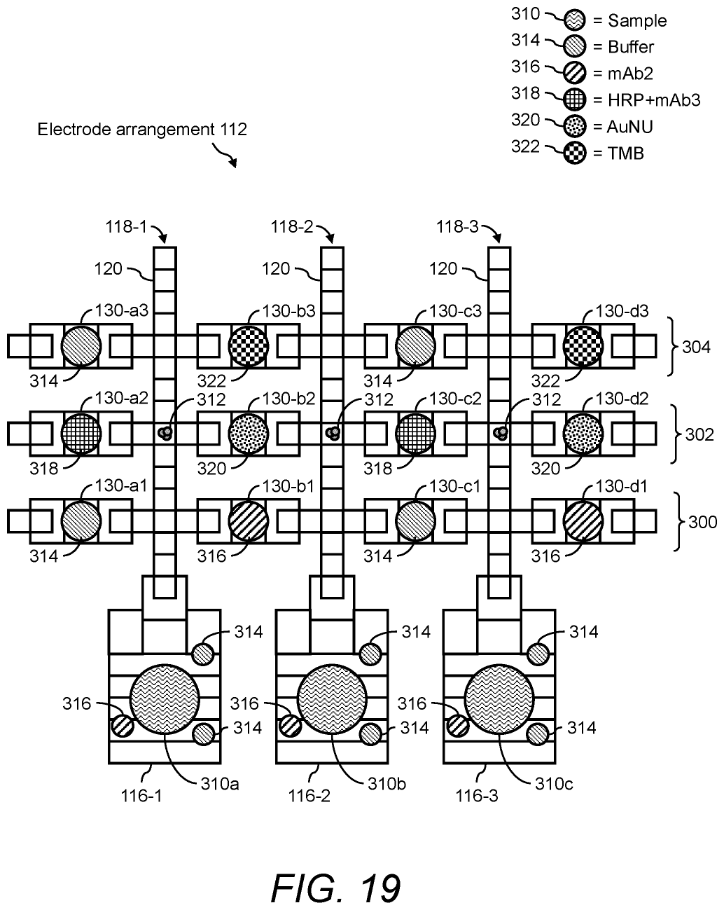

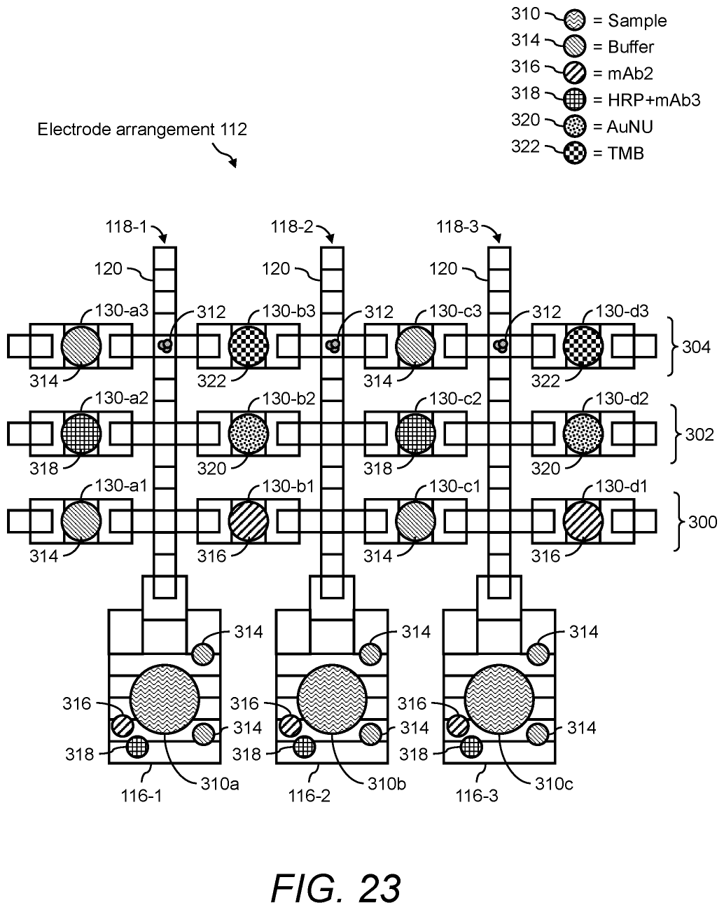

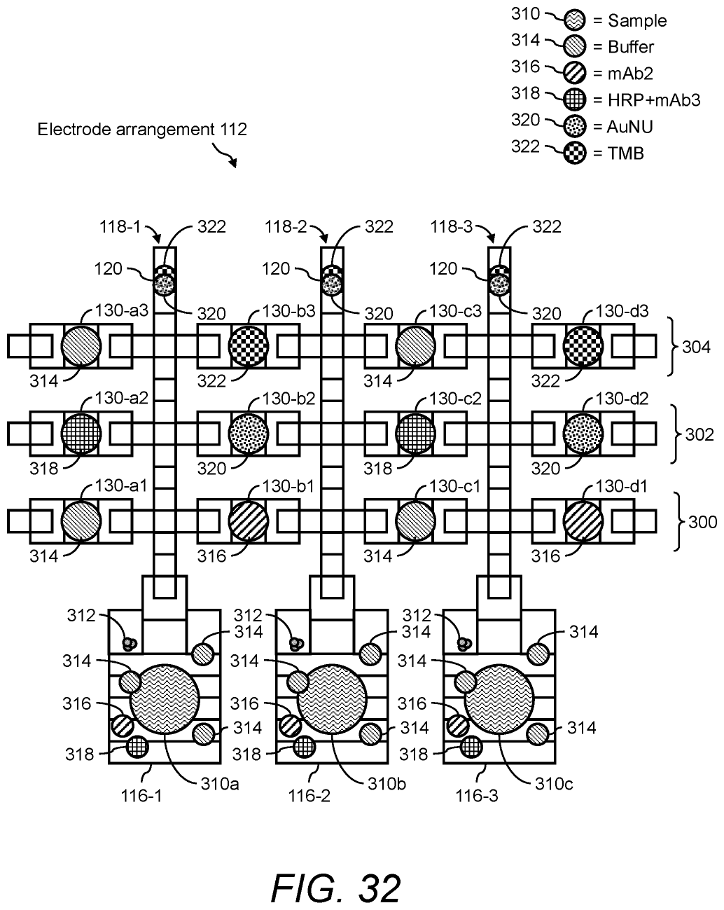

As described hereinbelow, a first stage of the assay can be performed at droplet operations station 300, as shown in FIG. 9 through FIG. 18. A second stage of the assay can be performed at droplet operations station 302, as shown in FIG. 19 through FIG. 22. A third stage of the assay can be performed at droplet operations station 304, as shown in FIG. 23 through FIG. 31. Then, the detection portion of the assay can be performed at LSPR sensors 120, as shown in FIG. 32.

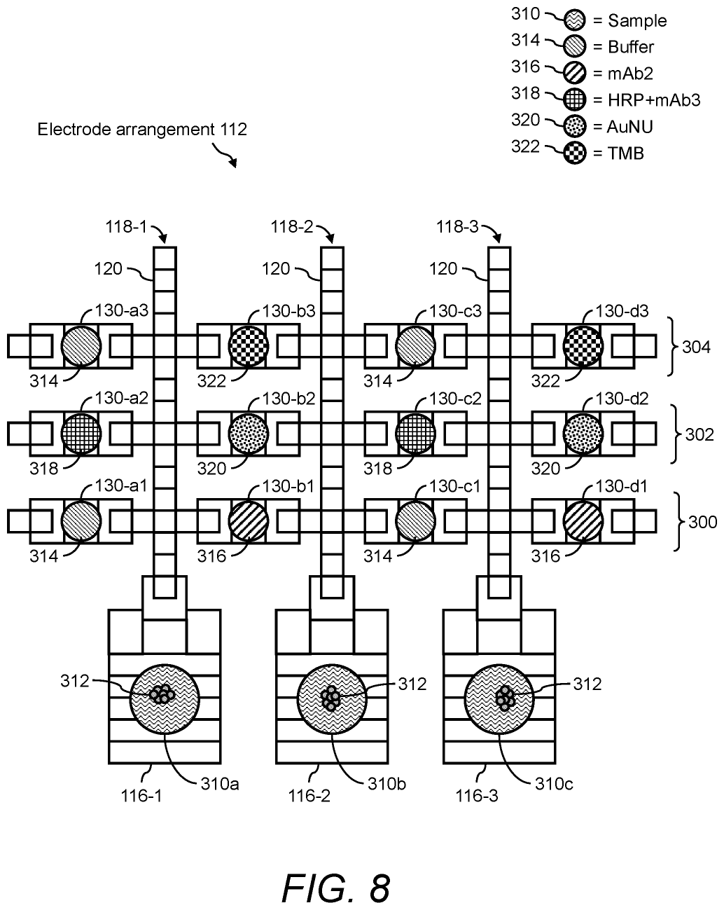

Referring to FIG. 7 through FIG. 32, the magnetic bead assay for COVID-19 can be run in microfluidics cartridge 110 of microfluidics system 100 using droplet operations. An example of the process steps of the magnetic bead assay for COVID-19 may be as follows. First, FIG. 8 shows that the magnetically responsive beads 312 can be consolidated within each of sample volumes 310a, 310b, 310c. For example, magnetically responsive beads 312 can be consolidated using magnets 160 in relation to microfluidics cartridge 110.

Next, FIG. 9 shows a buffer droplet 314 can be dispensed from dual-sided dispenser 130-a1 onto flow path 118-1. At the same time, a buffer droplet 314 can be dispensed from dual-sided dispenser 130-c1 onto flow path 118-3. Both using right-side dispensing.

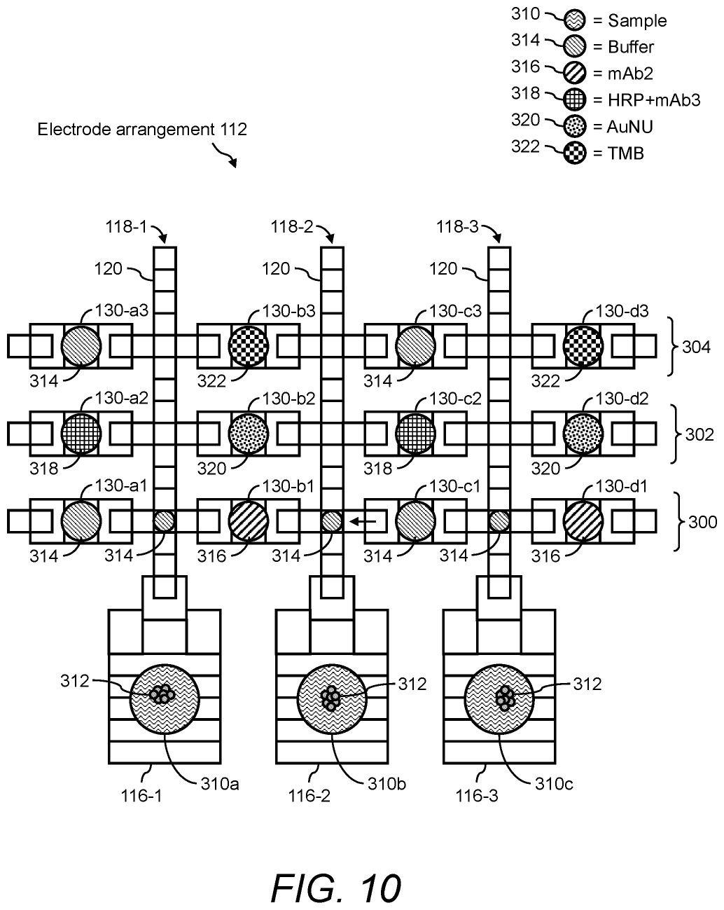

Next, FIG. 10 shows a buffer droplet 314 can be dispensed from dual-sided dispenser 130-c1 onto flow path 118-2 using left-side dispensing. This is an example of one dual-sided dispenser 130 (e.g., dual-sided dispenser 130-c1) being used to do both right-side and left-side dispensing to supply two different flow paths 118. Additionally, FIG. 9 and FIG. 10 show an efficient way to supply multiple flow paths 118 simultaneously in an assay. At this point, the wash buffer has been fully dispensed at droplet operations station 300.

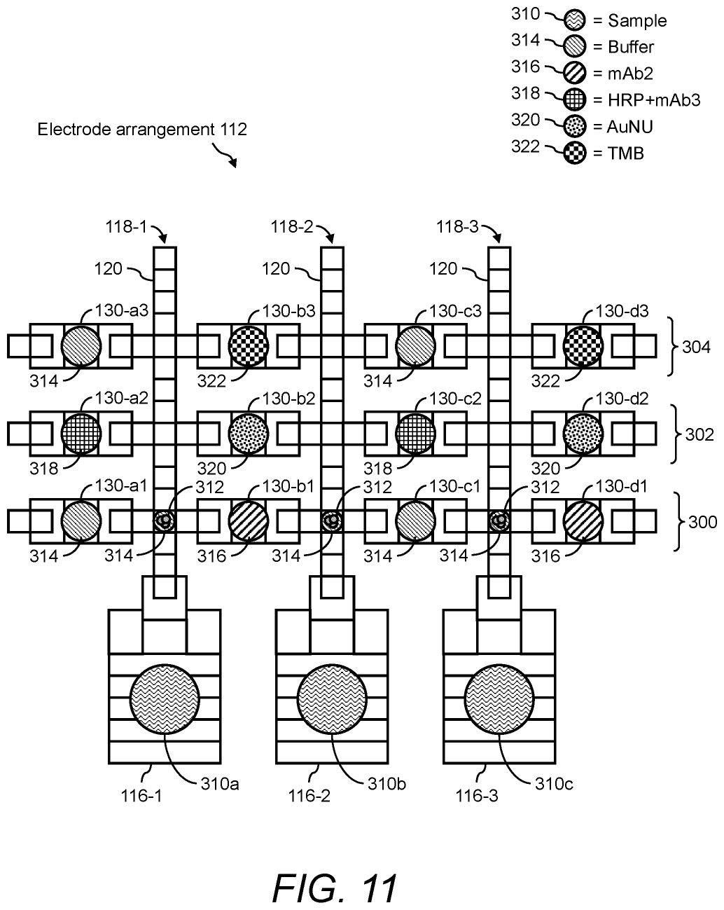

Next, FIG. 11 shows the consolidated magnetically responsive beads 312 can be moved (using magnets 160) from sample reservoirs 116-1, 116-2, 116-3 along their respective flow paths 118-1, 118-2, 118-3 and merged with the buffer droplets 314 at droplet operations station 300. Further, once in the buffer droplets 314, the magnetically responsive beads 312 can be resuspended and washed to remove any unbound material. In another example, the consolidated magnetically responsive beads 312 can be resuspended in a buffer droplet, then transported from sample reservoirs 116-1, 116-2, 116-3 to droplet operations station 300, then immobilized, and then the buffer removed.

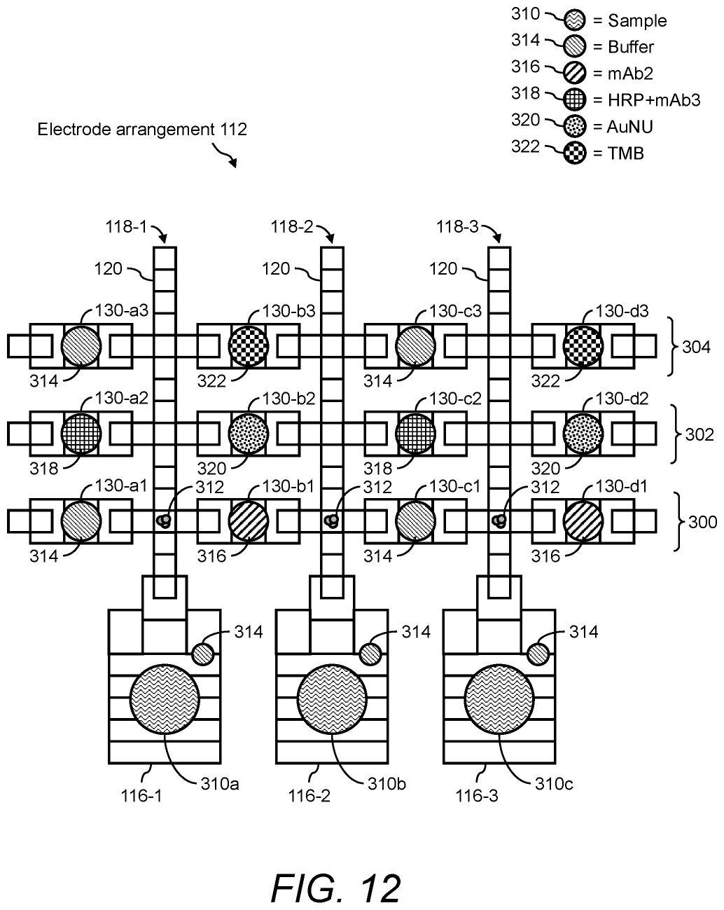

Next, FIG. 12 shows the wash buffer is sent to waste. For example, using droplet operations, the buffer droplets 314 are moved out of droplet operations station 300 to sample reservoirs 116-1, 116-2, 116-3. Sample reservoirs 116-1, 116-2, 116-3 are hereafter called waste reservoirs 116-1, 116-2, 116-3. At the same time, using magnets 160, the magnetically responsive beads 312 with any bound viral particles thereon can be held immobilized at their respective flow paths 118-1, 118-2, 118-3 and left behind at droplet operations station 300.

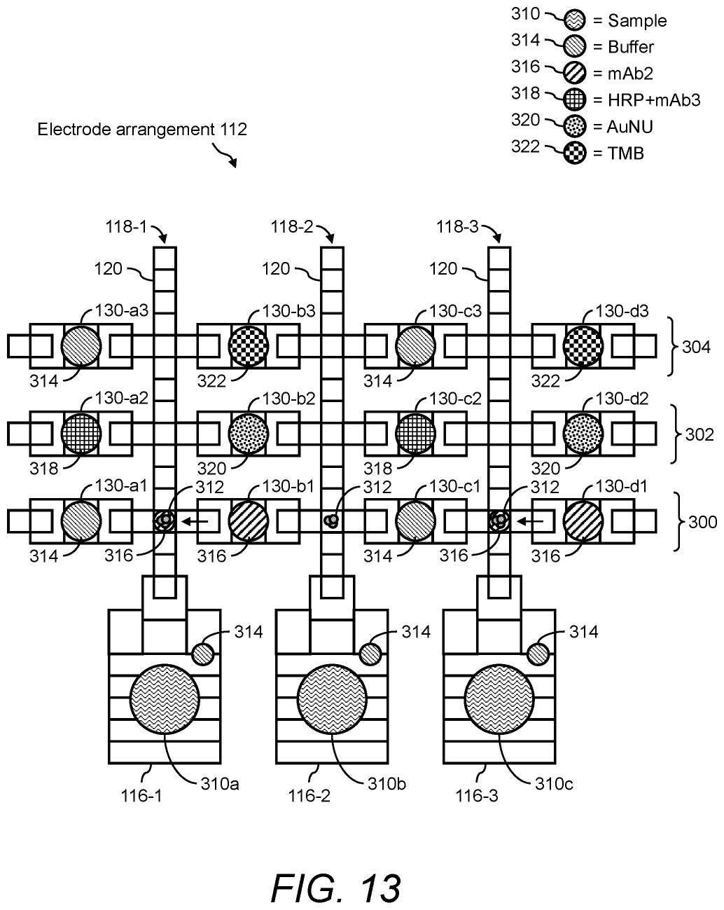

Next, FIG. 13 shows an mAb2 droplet 316 can be dispensed from dual-sided dispenser 130-b1 onto flow path 118-1. At the same time, an mAb2 droplet 316 can be dispensed from dual-sided dispenser 130-d1 onto flow path 118-3. Both using left-side dispensing.

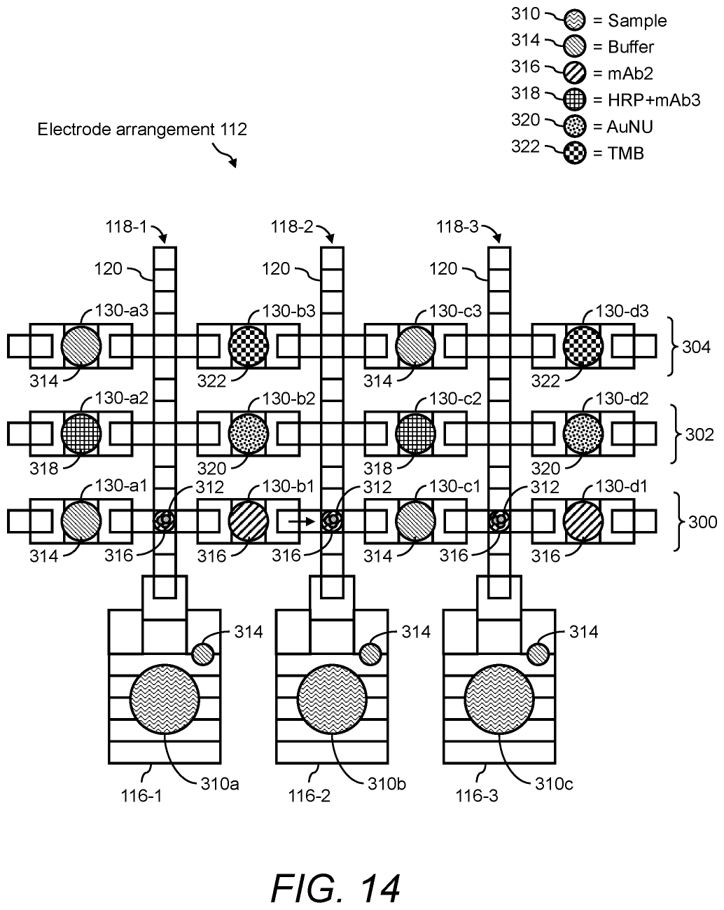

Next, FIG. 14 shows an mAb2 droplet 316 can be dispensed from dual-sided dispenser 130-b1 onto flow path 118-2 using right-side dispensing. At this point, the detection antibody mAb2 has been fully dispensed at droplet operations station 300 and the magnetically responsive beads 312 are resuspended and allowed to incubate in the mAb2 droplets 316. In the presence of any bead-bound viral particles, an mAb2-viral particle complex is formed.

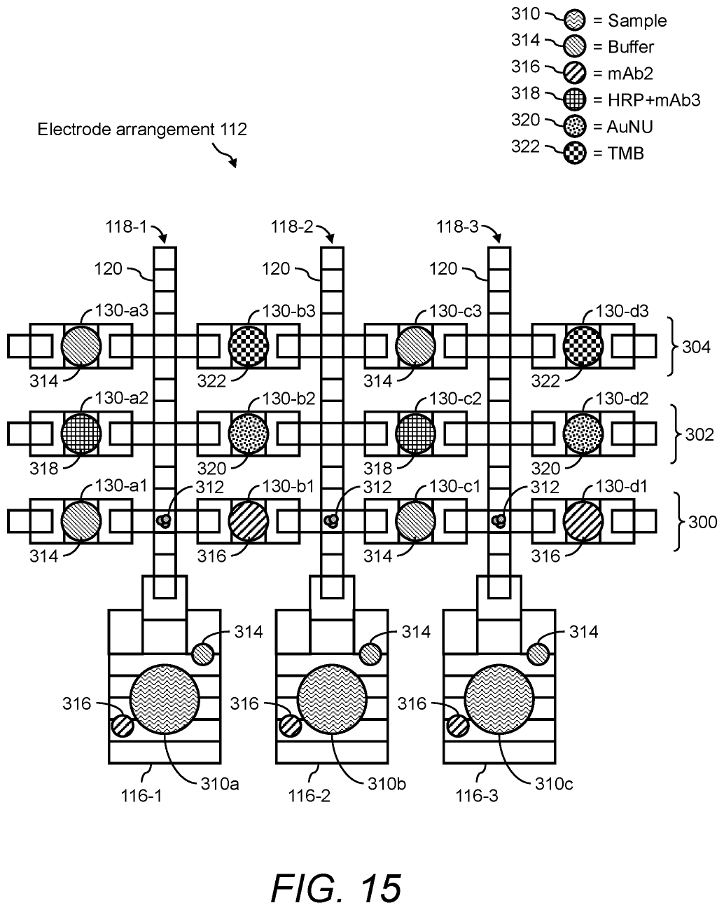

Next, FIG. 15 shows the mAb2 solution is sent to waste. For example, using droplet operations, the mAb2 droplets 316 are moved out of droplet operations station 300 to waste reservoirs 116-1, 116-2, 116-3. At the same time, using magnets 160, the magnetically responsive beads 312 can be held immobilized at their respective flow paths 118-1, 118-2, 118-3 and left behind at droplet operations station 300.

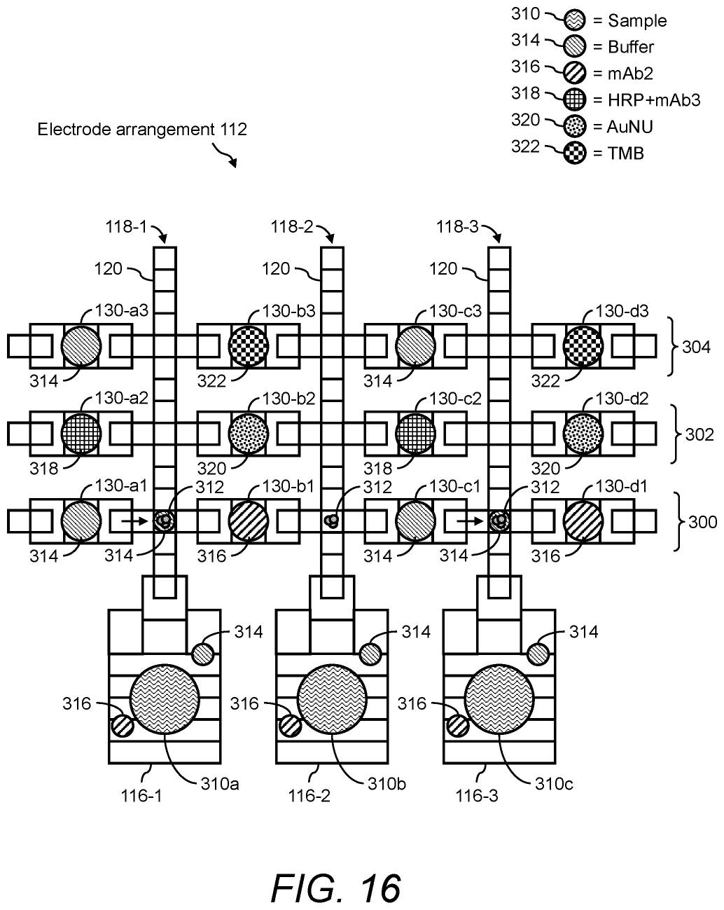

Next, FIG. 16 shows a buffer droplet 314 can be dispensed from dual-sided dispenser 130-a1 onto flow path 118-1. At the same time, a buffer droplet 314 can be dispensed from dual-sided dispenser 130-c1 onto flow path 118-3. Both using right-side dispensing.

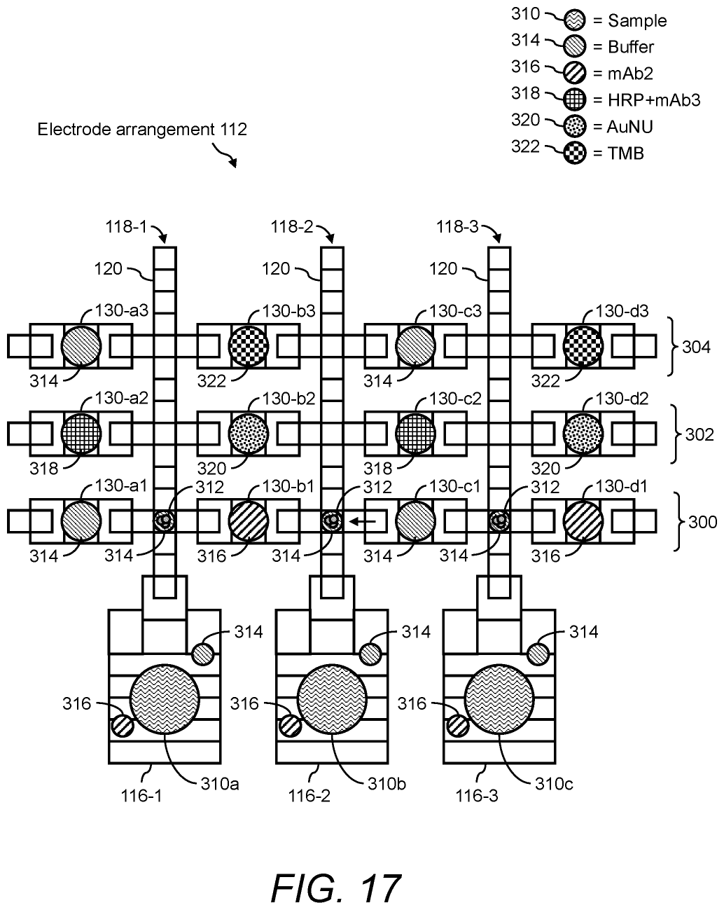

Next, FIG. 17 shows a buffer droplet 314 can be dispensed from dual-sided dispenser 130-c1 onto flow path 118-2 using left-side dispensing. At this point, again the wash buffer has been fully dispensed at droplet operations station 300. Further, once in the buffer droplets 314, the magnetically responsive beads 312 can be resuspended and washed.

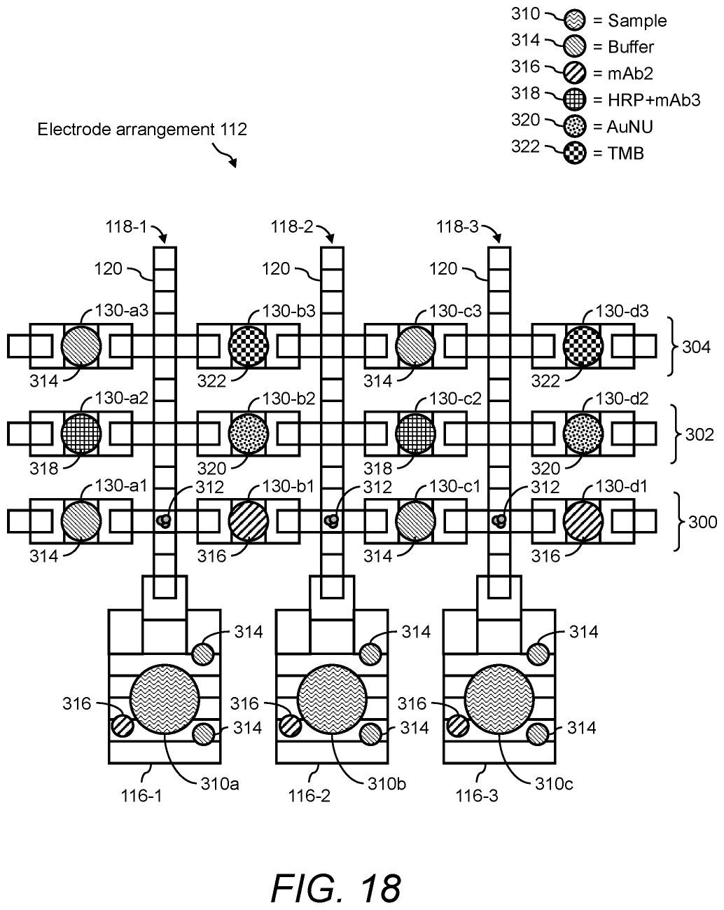

Next, FIG. 18 shows the wash buffer is sent to waste. For example, using droplet operations, the buffer droplets 314 are moved out of droplet operations station 300 to waste reservoirs 116-1, 116-2, 116-3. At the same time, using magnets 160, the magnetically responsive beads 312 can be held immobilized at their respective flow paths 118-1, 118-2, 118-3 and left behind at droplet operations station 300.

Next, FIG. 19 shows the magnetically responsive beads 312 can be moved (using magnets 160) along their respective flow paths 118-1, 118-2, 118-3 from droplet operations station 300 (i.e., the “1” row of dual-sided dispensers 130) to droplet operations station 302 (i.e., the “2” row of dual-sided dispensers 130). In another example, the magnetically responsive beads 312 can be resuspended in a buffer droplet, then transported from droplet operations station 300 to droplet operations station 302, then immobilized, and then the buffer removed.

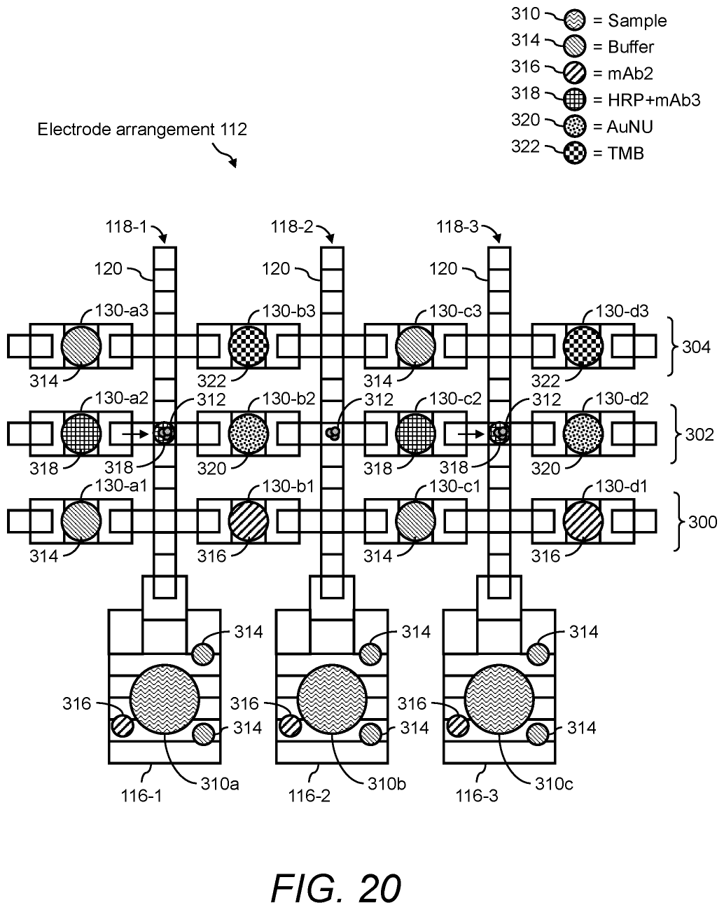

Next, FIG. 20 shows an HRP+mAb3 droplet 318 can be dispensed from dual-sided dispenser 130-a2 onto flow path 118-1. At the same time an HRP+mAb3 droplet 318 can be dispensed from dual-sided dispenser 130-c2 onto flow path 118-3. Both using right-side dispensing.

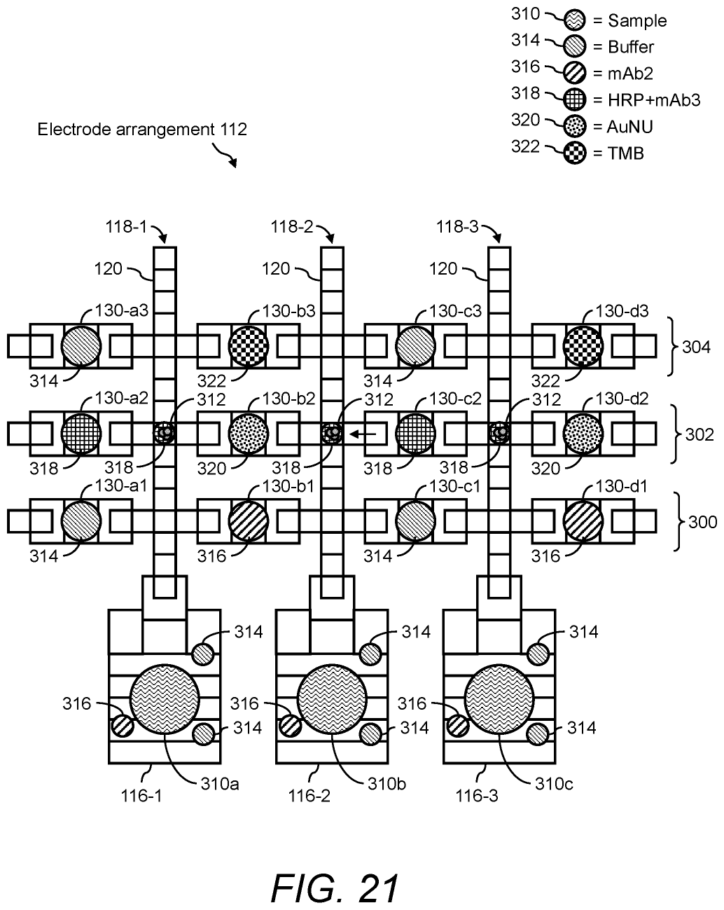

Next, FIG. 21 shows an HRP+mAb3 droplet 318 can be dispensed from dual-sided dispenser 130-c2 onto flow path 118-2 using left-side dispensing. At this point, the HRP+mAb3 solution (i.e., the secondary detection antibody) has been fully dispensed at droplet operations station 302 and the magnetically responsive beads 312 are resuspended and allowed to incubate in the HRP+mAb3 droplets 318. In the presence of any bead-bound viral particles, an mAb3-mAb2-viral particle complex is formed.

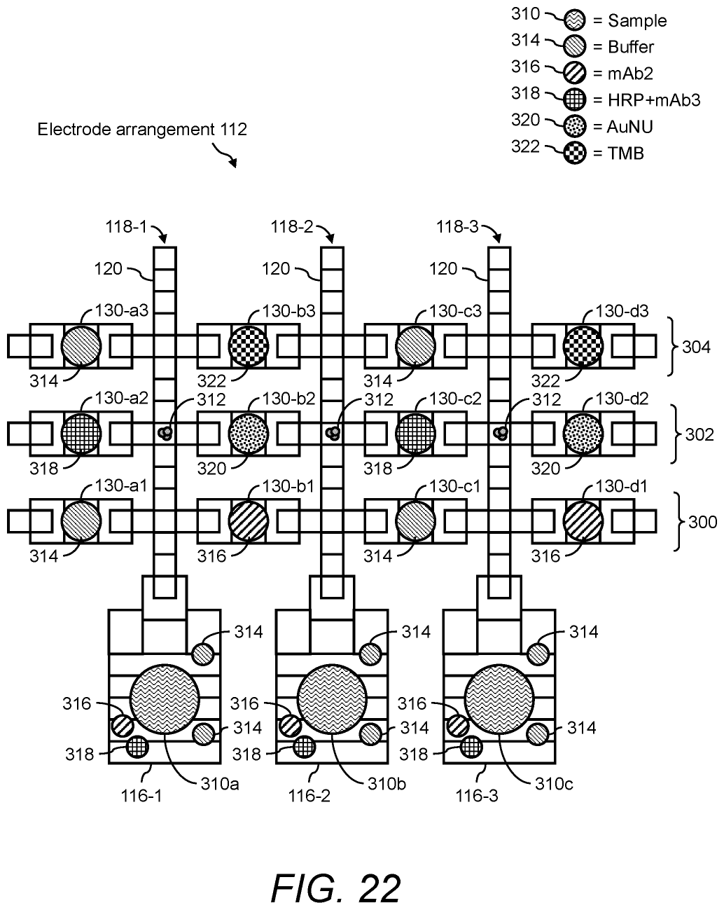

Next, FIG. 22 shows the HRP+mAb3 droplets 318 is sent to waste. For example, using droplet operations, the HRP+mAb3 droplets 318 are moved out of droplet operations station 302 to waste reservoirs 116-1, 116-2, 116-3. At the same time, using magnets 160, the magnetically responsive beads 312 can be held immobilized at their respective flow paths 118-1, 118-2, 118-3 and left behind at droplet operations station 302.

Next, FIG. 23 shows the magnetically responsive beads 312 can be moved (using magnets 160) along their respective flow paths 118-1, 118-2, 118-3 from droplet operations station 302 (i.e., the “2” row of dual-sided dispensers 130) to droplet operations station 304 (i.e., the “3” row of dual-sided dispensers 130). In another example, the magnetically responsive beads 312 can be resuspended in a buffer droplet, then transported from droplet operations station 302 to droplet operations station 304, then immobilized, and then the buffer removed.

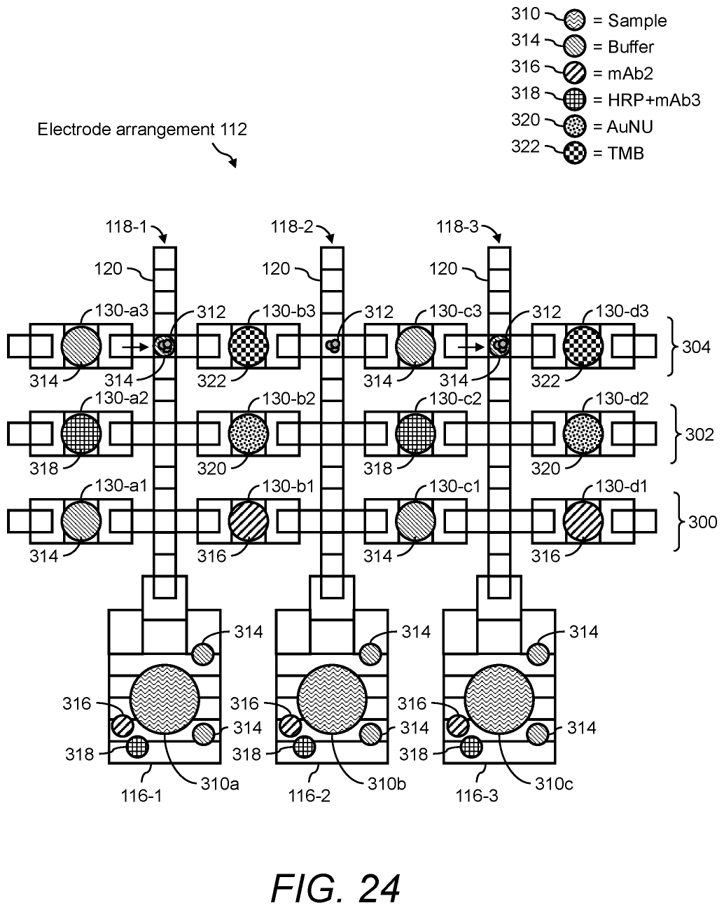

Next, FIG. 24 shows a buffer droplet 314 can be dispensed from dual-sided dispenser 130-a3 onto flow path 118-1. At the same time, a buffer droplet 314 can be dispensed from dual-sided dispenser 130-c3 onto flow path 118-3. Both using right-side dispensing.

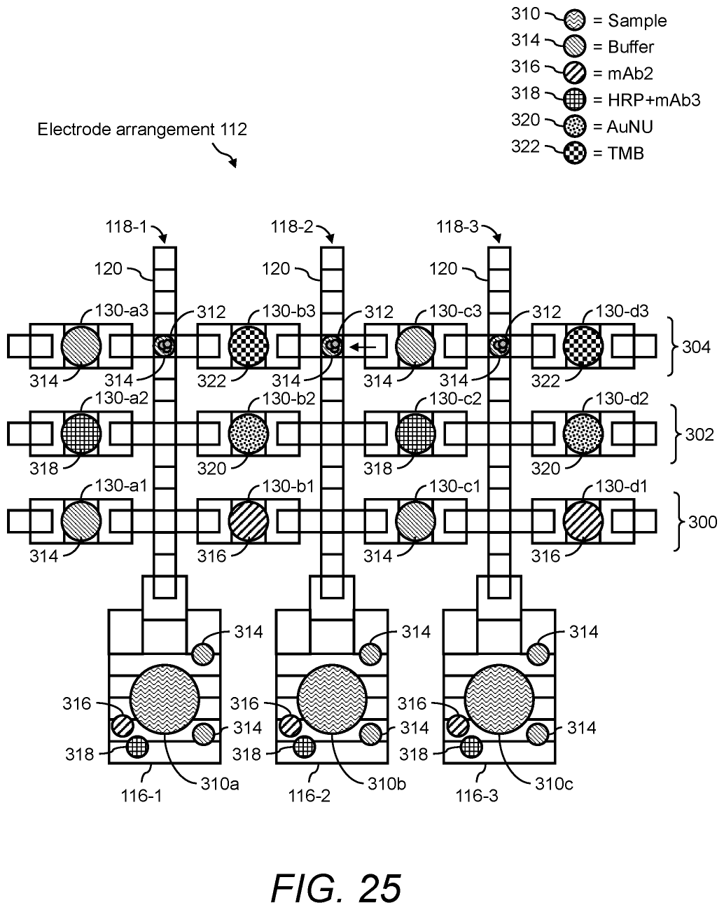

Next, FIG. 25 shows a buffer droplet 314 can be dispensed from dual-sided dispenser 130-c3 onto flow path 118-2 using left-side dispensing. At this point, the wash buffer has been fully dispensed at droplet operations station 304. Further, once in the buffer droplets 314, the magnetically responsive beads 312 can be resuspended and washed.

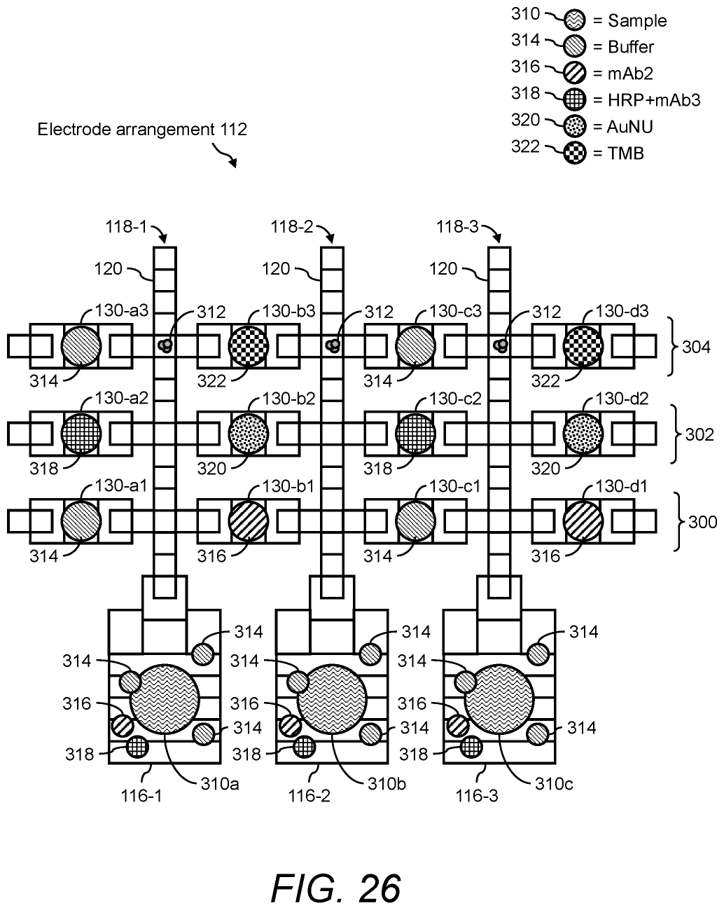

Next, FIG. 26 shows the wash buffer is sent to waste. For example, using droplet operations, the buffer droplets 314 are moved out of droplet operations station 304 to waste reservoirs 116-1, 116-2, 116-3. At the same time, using magnets 160, the magnetically responsive beads 312 with any mAb3-mAb2-viral particle complexes thereon can be held immobilized at their respective flow paths 118-1, 118-2, 118-3 and left behind at droplet operations station 304.

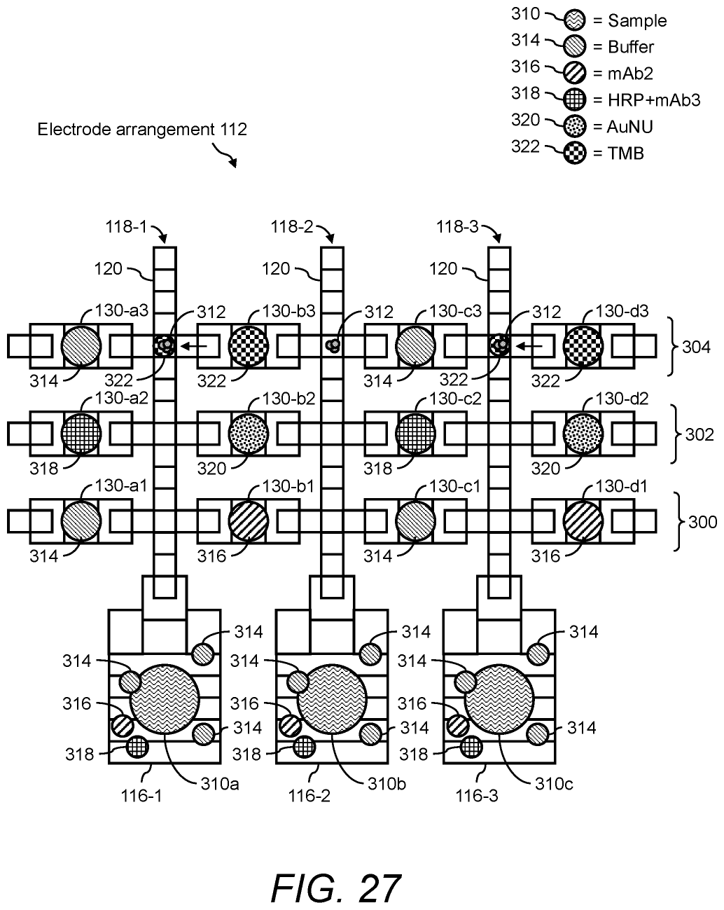

Next, FIG. 27 shows an TMP droplet 322 can be dispensed from dual-sided dispenser 130-b3 onto flow path 118-1. At the same time, an TMP droplet 322 can be dispensed from dual-sided dispenser 130-d3 onto flow path 118-3. Both using left-side dispensing.

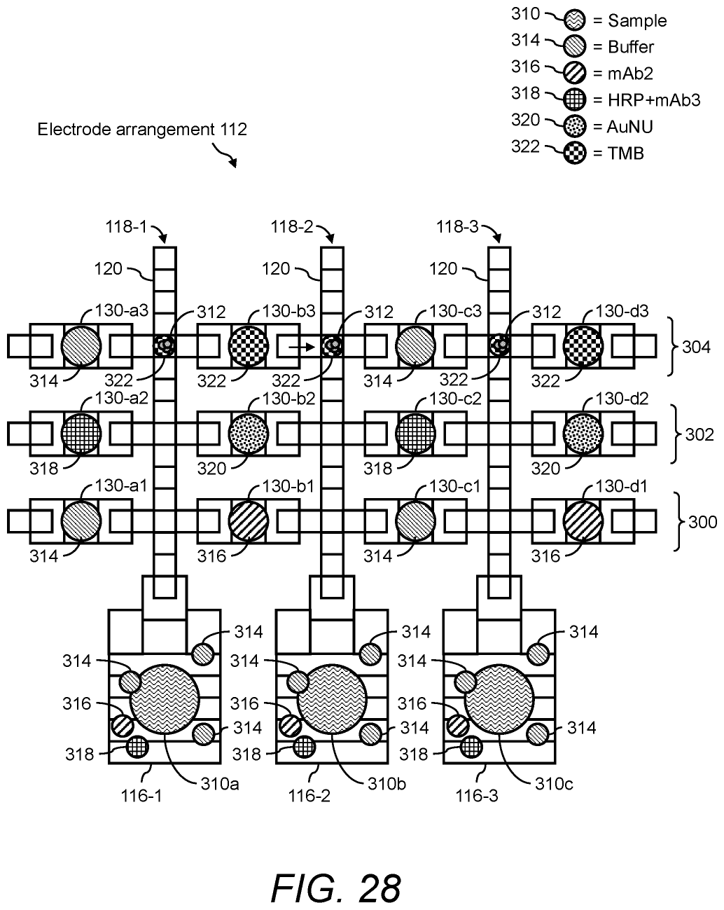

Next, FIG. 28 shows an TMP droplet 322 can be dispensed from dual-sided dispenser 130-b3 onto flow path 118-2 using right-side dispensing. At this point, the TMP solution (i.e., the HRP substrate) has been fully dispensed at droplet operations station 304 and the magnetically responsive beads 312 with any mAb3-mAb2-viral particle complexes thereon are resuspended and allowed to incubate in the TMP droplets 322. In the presence of any antibody-viral particle complexes, HRP converts TMB to an oxidized colored product.

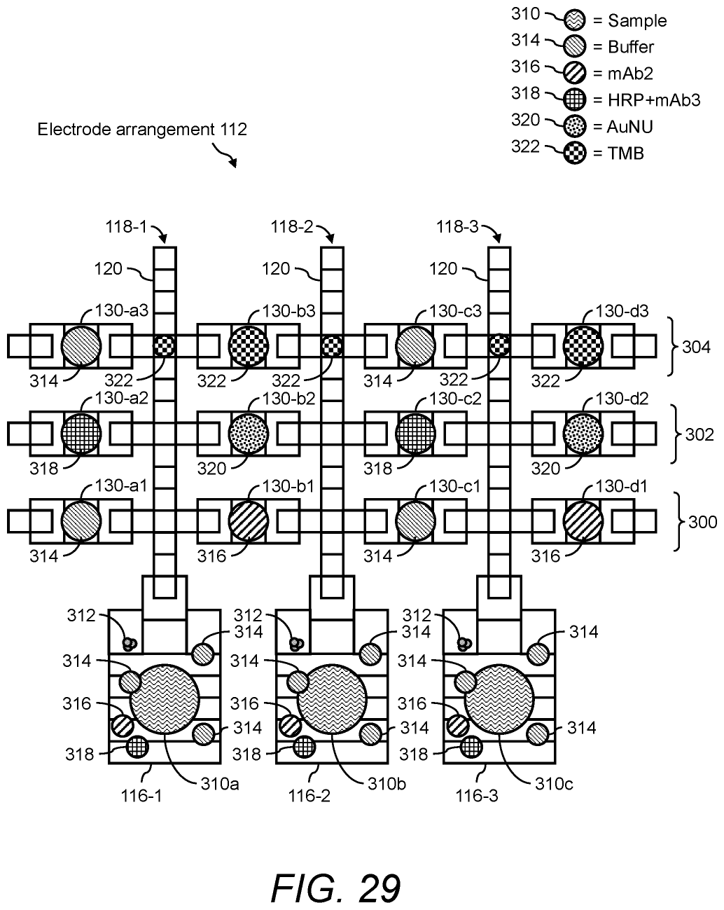

Next, FIG. 29 shows the magnetically responsive beads 312 can be moved (using magnets 160) from their respective flow paths 118-1, 118-2, 118-3 at droplet operations station 304 to waste reservoirs 116-1, 116-2, 116-3. TMP droplets 322 with any HRP-converted oxidized TMB colored product therein are left at droplet operations station 304.

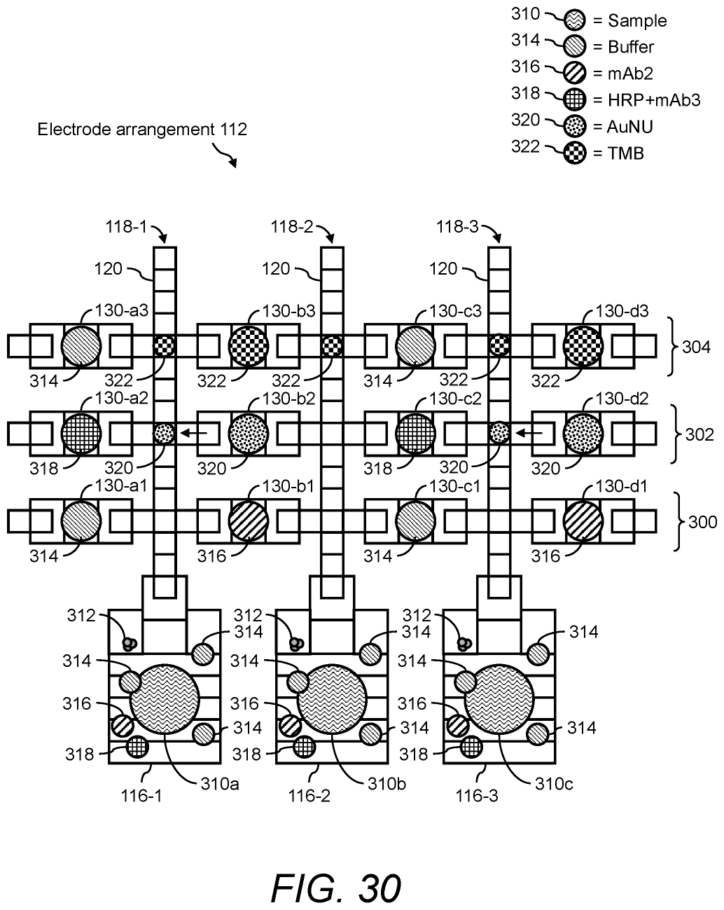

Next, FIG. 30 shows an AuNU droplet 320 can be dispensed from dual-sided dispenser 130-b2 onto flow path 118-1 at droplet operations station 302. At the same time, an AuNU droplet 320 can be dispensed from dual-sided dispenser 130-d2 onto flow path 118-3 at droplet operations station 302. Both using left-side dispensing.

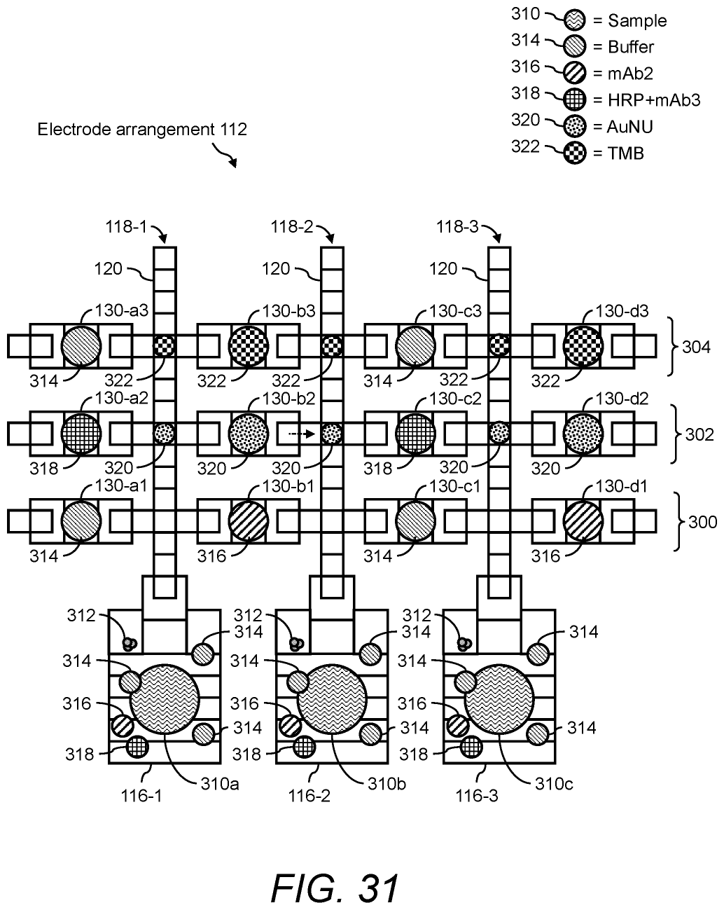

Next, FIG. 31 shows an AuNU droplet 320 can be dispensed from dual-sided dispenser 130-b2 onto flow path 118-2 at droplet operations station 302 and using right-side dispensing. At this point, AuNU droplets 320 are sitting at flow paths 118-1, 118-2, 118-3 of droplet operations station 302 and TMP droplets 322 are sitting at flow paths 118-1, 118-2, 118-3 of droplet operations station 304.

Next, FIG. 32 shows both the AuNU droplets 320 and the TMP droplets 322 moved via droplet operations to LSPR sensors 120 at the ends of flow paths 118-1, 118-2, 118-3. At each of the LSPR sensors 120, the AuNU droplets 320 and TMP droplets 322 (with any HRP-converted oxidized TMB colored product therein) are merged. Any color change generated in the HRP-TMB reaction is amplified due to etching of the gold nano-urchins (AuNU) in the AuNU droplets 320, which is proportional to the concentration of the oxidized TMB colored product in the TMP droplets 322. Then, readings from LSPR sensors 120 are collected and processed by controller 150 of DMF instrument 105 and the assay is complete.

In the magnetic bead assay described hereinabove with respect to FIG. 7 through FIG. 32, certain benefits of dual-sided dispensers 130 compared with conventional assays can include, but are not limited to, the following:
dual-sided dispensers 130 provide an efficient way to supply multiple flow paths 118 simultaneously in an assay;
individual dual-sided dispensers 130 can be used to do both right-side and left-side dispensing to supply two different flow paths 118;
at any droplet operations station (e.g., 300, 302, 304), multiple dual-sided dispensers 130 can act in parallel;
using dual-sided dispensers 130, each droplet operations station (e.g., 300, 302, 304) can be used to facilitate interactions between multiple types of liquids; and
the arrangement of dual-sided dispensers 130 allows the transport distance between operations to be minimized (i.e., by minimizing the number of droplet operations electrodes) compared with conventional electrode configurations.

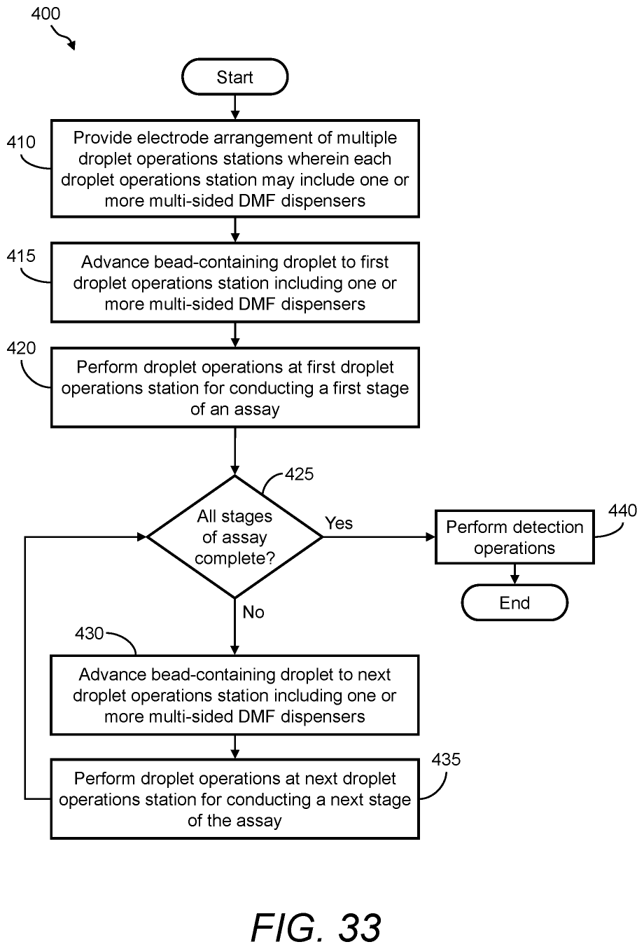

Referring to FIG. 33 is a flow diagram of an example of a method 400 of performing an assay using the presently disclosed microfluidics system 100 including the multi-sided or multi-outlet dispensers 130. In method 400, microfluidics system 100 can include an z×n array or matrix 250 of dual-sided dispensers 130 and wherein certain portions of the z×n array or matrix 250 of dual-sided dispensers 130 can be designated as droplet operations stations for performing certain stages of an assay, such as the magnetic bead assay shown in FIG. 7 through FIG. 32.

Method 400 may include, but is not limited to, the following steps.

At a step 410, an electrode arrangement is provided including multiple droplet operations stations and wherein each droplet operations station can include one or more multi-sided or multi-outlet dispensers 130. In one example, an electrode arrangement 112 is provided that can include multiple droplet operations stations, such as droplet operations stations 300, 302, 304 as shown in FIG. 7 through FIG. 32. In this example, each of the droplet operations stations 300, 302, 304 can include one or more multi-sided dispensers 130, such as the multiple dual-sided dispensers 130 shown in FIG. 7 through FIG. 32. Method 400 proceeds to method step 415.

At a step 415, a bead-containing droplet is advanced to the first droplet operations station including one or more multi-sided dispensers 130. In one example and referring now to FIG. 9 through FIG. 18, a bead-containing droplet is advanced via droplet operations to droplet operations station 300 including multiple dual-sided dispensers 130. Method 400 proceeds to method step 420.

At a step 420, droplet operations are performed at the first droplet operations station for conducting a first stage of an assay. In one example and referring now to FIG. 9 through FIG. 18, droplet operations are performed at droplet operations station 300 for conducting stage one of the assay. Method 400 proceeds to method step 425.

At a decision step 425, it is determined whether all stages of the assay are complete. If all stages of the assay are complete, then method 400 proceeds to method step 440. However, if all stages of the assay are not complete, then method 400 proceeds to method step 430.

At a step 430, the bead-containing droplet is advanced to the next droplet operations station including one or more multi-sided dispensers 130. In one example and referring now to FIG. 19 through FIG. 22, a bead-containing droplet can be advanced via droplet operations to droplet operations station 302 including multiple dual-sided dispensers 130. In another example and referring now to FIG. 23 through FIG. 31, a bead-containing droplet can be advanced via droplet operations to droplet operations station 304 including multiple dual-sided dispensers 130.

Method 400 proceeds to method step 435.

At a step 435, droplet operations are performed at the next droplet operations station for conducting a next stage of the assay. In one example and referring now to FIG. 19 through FIG. 22, droplet operations can be performed at droplet operations station 302 for conducting an assay. In another example and referring now to FIG. 23 through FIG. 31, droplet operations can be performed at droplet operations station 304 for conducting an assay. Method 400 returns to method step 425.

At a step 440, detection operations are performed. For example and referring now to FIG. 32, detection operations can be performed at one or more LSPR sensors 120. More specifically, to summarize the example shown in FIG. 7 through FIG. 32, bead-bound virus+HRP enzyme+TMB substrate=oxidized colored product. Then, merge the “product droplet” (the beads are now gone to waste) with the AuNU droplet. Then, the oxidized product etches the gold nano-urchins which amplifies the color change and increases the assay sensitivity. Readings from LSPR sensors 120 can be collected and processed by controller 150 of DMF instrument 105. In another example, optical detection can be performed at a certain detection spot 115 via illumination source 156 and optical measurement device 158 of detection system 154. Method 400 ends.

Multi-sided or multi-outlet dispensers 130 are not limited to dual-sided dispensers 130 as described hereinabove with reference to FIG. 2A through FIG. 32. Three- and four-sided dispensers 130 are possible as described hereinbelow with reference to FIG. 34 and FIG. 35.

Referring to FIG. 34 is a plan view of an example of a triple-sided dispenser 130, which is another example of the multi-sided dispensers 130 of the microfluidics system 100 shown in FIG. 1. For example, triple-sided dispenser 130 can include a line of dispenser electrodes 113 with an arrangement of droplet operations electrodes 114 leading away from both ends of the line and away from one side of the line. In one example, triple-sided dispenser 130 can include a line of three dispenser electrodes 113. Further, an arrangement of droplet operations electrodes 114 can be provided leading away from one end of the line of three dispenser electrodes 113 to provide outlet 132-1. Further, another arrangement of droplet operations electrodes 114 can be provided leading away from the other end of the line of three dispenser electrodes 113 to provide outlet 132-2. Further, another arrangement of droplet operations electrodes 114 can be provided leading away from one side of the line of three dispenser electrodes 113 to provide outlet 132-3. In triple-sided dispenser 130, dispensing from outlet 132-1 can be called “left-side” dispensing, dispensing from outlet 132-1 can be called “right-side” dispensing, and dispensing from outlet 132-3 can be called “top-side” dispensing.

Referring to FIG. 35 is a plan view of an example of a quad-sided dispenser 130, which is another example of the multi-sided dispensers 130 of the microfluidics system 100 shown in FIG. 1. For example, quad-sided dispenser 130 can include a line of dispenser electrodes 113 with an arrangement of droplet operations electrodes 114 leading away from both ends of the line and away from one side of the line. In one example, quad-sided dispenser 130 can include a line of three dispenser electrodes 113. Further, an arrangement of droplet operations electrodes 114 can be provided leading away from one end of the line of three dispenser electrodes 113 to provide outlet 132-1. Further, another arrangement of droplet operations electrodes 114 can be provided leading away from the other end of the line of three dispenser electrodes 113 to provide outlet 132-2. Further, another arrangement of droplet operations electrodes 114 can be provided leading away from one side of the line of three dispenser electrodes 113 to provide outlet 132-3. Further, another arrangement of droplet operations electrodes 114 can be provided leading away from the other side of the line of three dispenser electrodes 113 to provide outlet 132-4. In quad-sided dispenser 130, dispensing from outlet 132-1 can be called “left-side” dispensing, dispensing from outlet 132-1 can be called “right-side” dispensing, dispensing from outlet 132-3 can be called “top-side” dispensing, and dispensing from outlet 132-4 can be called “bottom-side” dispensing.

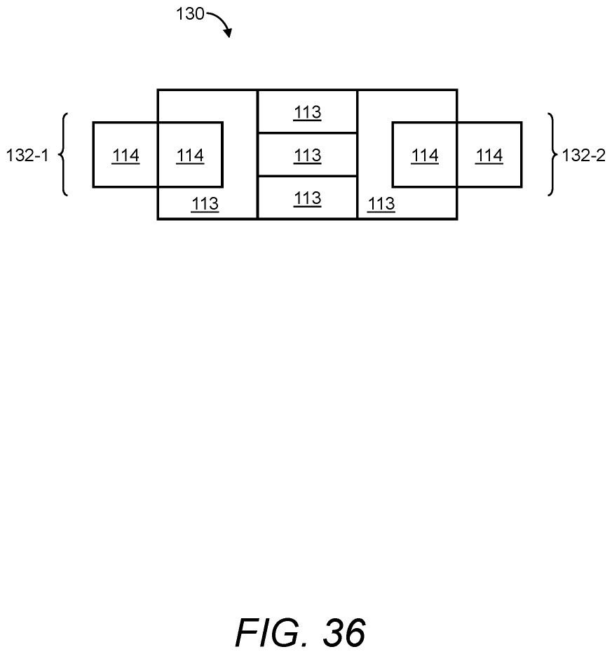

Referring to FIG. 36 is a plan view of another example of a dual-sided dispenser 130. This example of dual-sided dispenser 130 is substantially the same as the dual-sided dispenser 130 shown and described hereinabove in FIG. 2A except for the centermost dispenser electrode 113. Here, the centermost dispenser electrode 113 can be split into multiple (e.g., three) dispenser electrodes 113 to provide more droplet operations control with respect to moving liquid to any outlet 132.

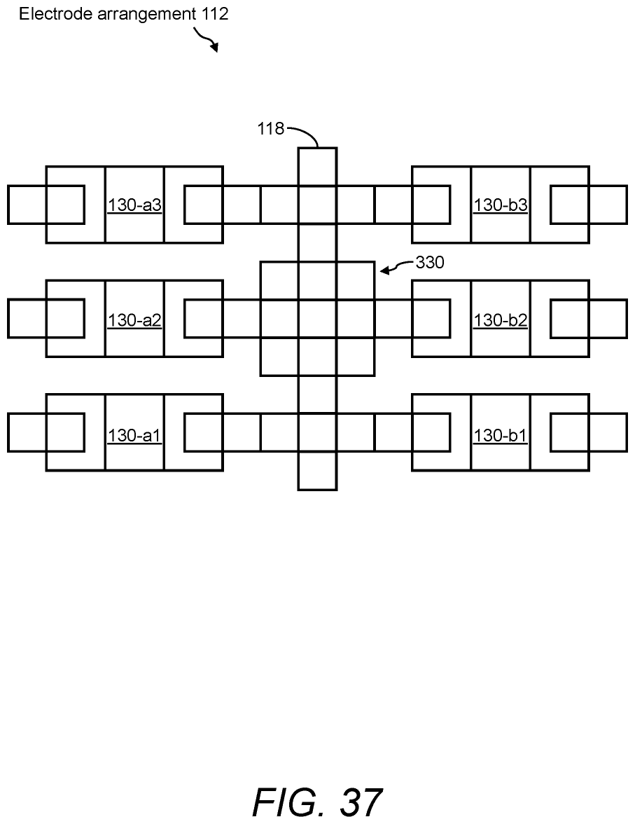

Referring to FIG. 37 is a plan view of an electrode configuration 112 that can include an example of a mixer array 330 arranged with respect to multiple dual-sided dispensers 130. In this example, mixer array 330 can be an array (e.g., 3×3) of droplet operations electrodes 114. Mixer array 330 can be provided in a certain line of dual-sided dispensers 130, between two columns of dual-sided dispensers 130, and in flow path 118.

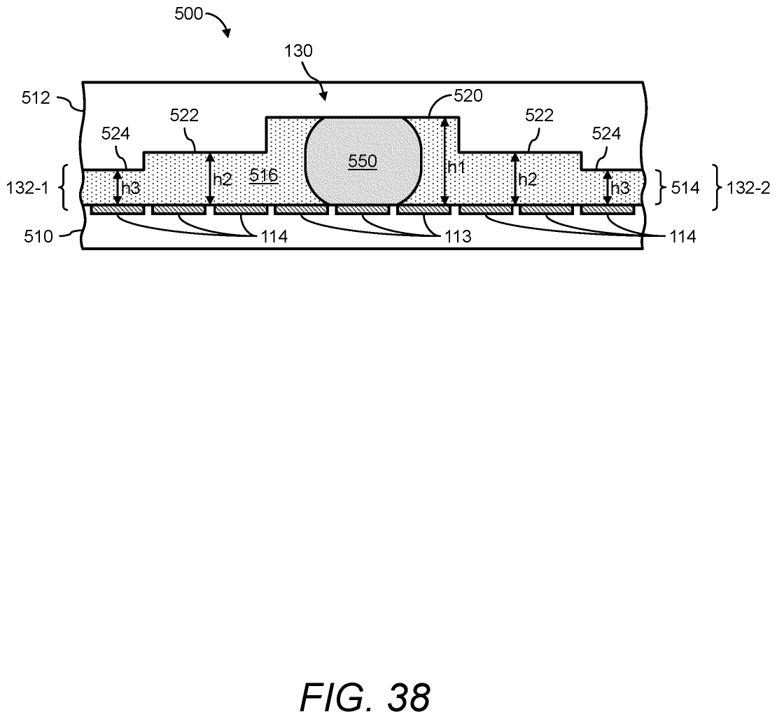

Referring to FIG. 38 is a side view of an example of a DMF structure 500 including a dual-sided dispenser 130 that can include multiple gap heights to facilitate simultaneous dual-sided dispensing. In one example, the formation of multi-sided dispensers 130 in microfluidics cartridge 110 of microfluidics system 100 can be based generally on DMF structure 500. DMF structure 500 can include any arrangements (e.g., lines, paths, arrays) of droplet operations electrodes 114 (i.e., electrowetting electrodes).

Further, DMF structure 500 can include a bottom substrate 510 and a top substrate 512 separated by a droplet operations gap 514. Droplet operations gap 514 can contain filler fluid 516, such as silicone oil. Bottom substrate 510 can be, for example, a silicon substrate or a PCB. Bottom substrate 510 can include an arrangement of droplet operations electrodes 114 (e.g., electrowetting electrodes). Droplet operations electrodes 114 can be formed, for example, of copper, gold, or aluminum. Top substrate 512 can be, for example, a glass or plastic substrate. Top substrate 512 can include a ground reference electrode (not shown). In one example, the ground reference electrode (not shown) can be formed of indium tin oxide (ITO) and wherein ITO is substantially transparent to light. Droplet operations can be conducted atop droplet operations electrodes 114 on a droplet operations surface. For example, droplet operations can be conducted atop droplet operations electrodes 114 with respect to a droplet 550.

In DMF structure 500, dual-sided dispenser 130 can include a line of dispenser electrodes 113 flanked on one end by droplet operations electrodes 114 leading to outlet 132-1 and flanked on the other end by droplet operations electrodes 114 leading to outlet 132-2.

In the portion of droplet operations gap 514 spanning dual-sided dispenser 130 multiple gap heights are provided. For example, a gap height h1 can be provided along a plane 520 of top substrate 512 and at the dispenser electrodes 113-portion of dual-sided dispenser 130. Then, a gap height h2 can be provided along a plane 522 of top substrate 512 and at each side of the dispenser electrodes 113-portion of dual-sided dispenser 130. Then, a gap height h3 can be provided along a plane 524 of top substrate 512 and at the two outlets 132 of dual-sided dispenser 130. In this example, the gap height h1 is greater than the gap height h2 and the gap height h2 is greater than the gap height h3. In one example, gap height h1 can be about 3 mm, gap height h2 can be about 1.5 mm, and gap height h3 can be about 0.5 mm.

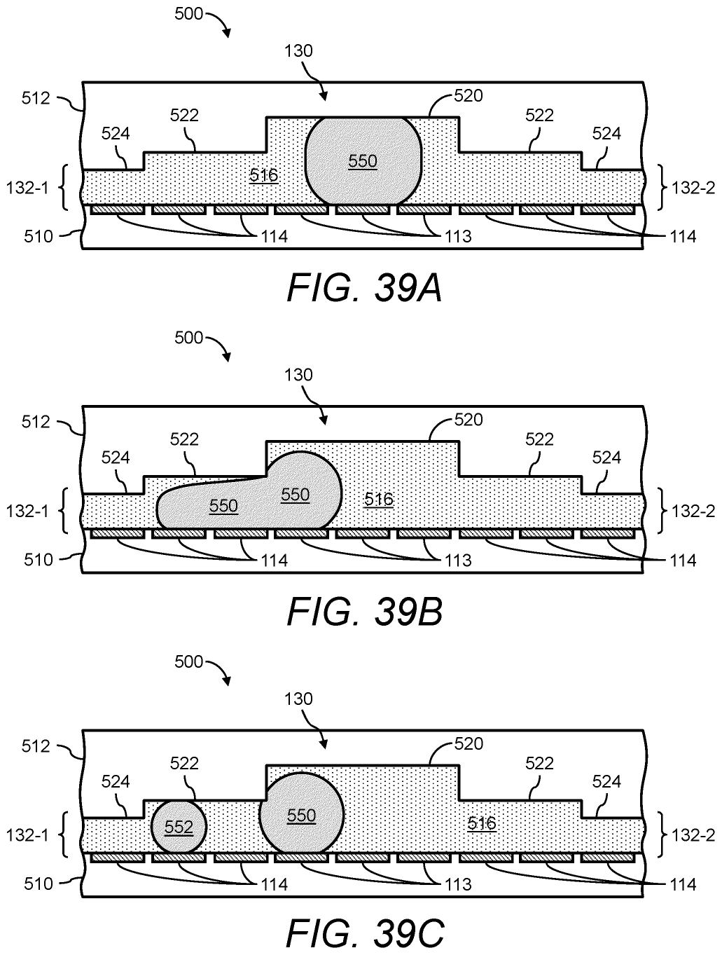

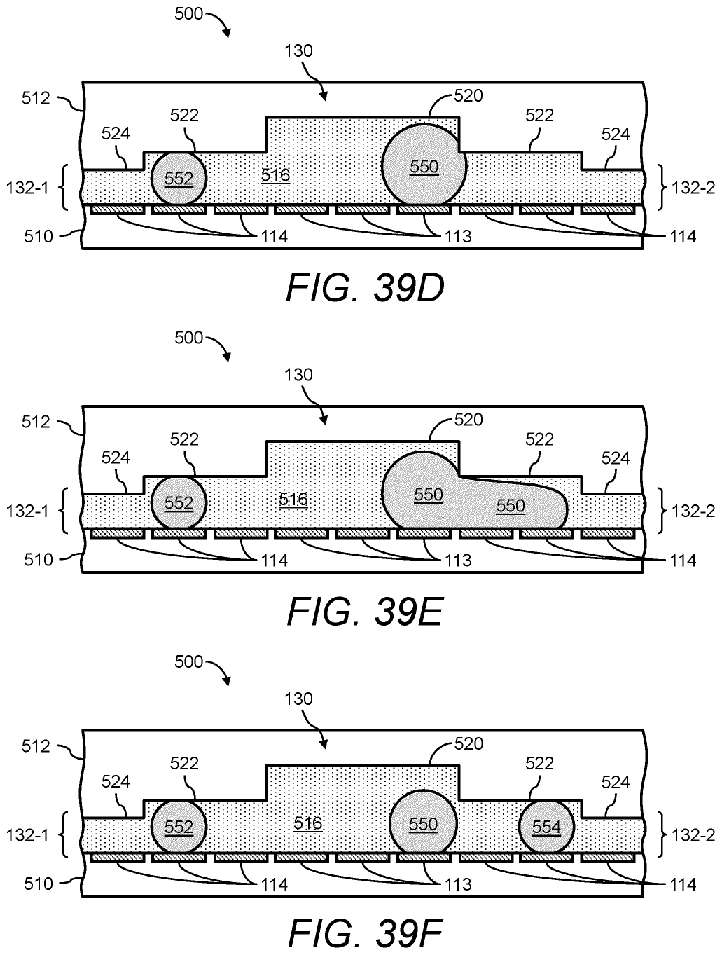

In the configuration of dual-sided dispenser 130 of DMF structure 500, the change in gap heights can be used advantageously to queue up or “prime” a droplet at both outlet 132-1 and outlet 132-2 and then dispense both droplets substantially simultaneously. In this way, a “simultaneous dual-sided dispense” process of dual-sided dispenser 130 can be enabled. More details of an example of a simultaneous dual-sided dispense process of dual-sided dispenser 130 is shown and described hereinbelow with reference to FIG. 39A through FIG. 39F.

Referring to FIG. 39A through FIG. 39F is side views showing an example of a simultaneous dual-sided dispense process using the dual-sided dispenser 130 of DMF structure 500 shown in FIG. 38.

For example, FIG. 39A shows a droplet 550 at the dispenser electrodes 113-portion of dual-sided dispenser 130, which is the gap height h1-portion of dual-sided dispenser 130. Droplet 550 has some starting volume prior to any dispensing operation.

FIG. 39B shows that, using droplet operations, droplet 550 can be moved toward outlet 132-1. Then, droplet operations electrodes 114 at the gap height h2-portion of dual-sided dispenser 130 can be activated. Accordingly, a slug of liquid 550 is drawn from the original droplet 550 into the gap height h2-portion of dual-sided dispenser 130.

FIG. 39C shows that, using droplet operations, a droplet 552 is split off the slug of liquid 550 and/or the original droplet 550. Then, droplet 552 can be left near the outlet 132-1 of dual-sided dispenser 130, which is the gap height h3-portion of dual-sided dispenser 130. In this way, dual-sided dispenser 130 that has multiple gap heights can be used to queue up or “prime” droplet 552 at outlet 132-1.

FIG. 39D shows that, using droplet operations, droplet 550 at the gap height h1-portion of dual-sided dispenser 130 can be moved toward outlet 132-2. Now droplet 550 has some lesser volume than the original droplet 550 (see FIG. 39A).

FIG. 39E shows that droplet operations electrodes 114 at the gap height h2-portion of dual-sided dispenser 130 can be activated. Accordingly, a slug of liquid 550 is drawn from the droplet 550 into the gap height h2-portion of dual-sided dispenser 130.

FIG. 39F shows that, using droplet operations, a droplet 554 is split off the slug of liquid 550 and/or the droplet 550. Then, droplet 554 can be left near the outlet 132-2 of dual-sided dispenser 130, which is the gap height h3-portion of dual-sided dispenser 130. In this way, dual-sided dispenser 130 that has multiple gap heights can be used to queue up or “prime” droplet 554 at outlet 132-2.

Accordingly, as shown in FIG. 39F, both droplet 552 and droplet 554 can be queued up or “primed” to be dispensed from dual-sided dispenser 130 at substantially the same time.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” “comprising,” “include,” “includes,” and “including,” are intended to be non-limiting, such that recitation of items in a list is not to the exclusion of other like items that may be substituted or added to the listed items.

Terms like “preferably,” “commonly,” and “typically” are not utilized herein to limit the scope of the claimed embodiments or to imply that certain features are critical or essential to the structure or function of the claimed embodiments. These terms are intended to highlight alternative or additional features that may or may not be utilized in a particular embodiment of the present disclosure.

The term “substantially” is utilized herein to represent the inherent degree of uncertainty that may be attributed to any quantitative comparison, value, measurement, or other representation and to represent the degree by which a quantitative representation may vary from a stated reference without resulting in a change in the basic function of the subject matter at issue.

Various modifications and variations of the disclosed methods, compositions and uses of the invention will be apparent to the skilled person without departing from the scope and spirit of the invention. Although the invention has been disclosed in connection with specific preferred aspects or embodiments, it should be understood that the invention as claimed should not be unduly limited to such specific aspects or embodiments.

The present invention may be implemented using hardware, software, or a combination thereof and may be implemented in one or more computer systems or other processing systems. In one aspect, the invention is directed toward one or more computer systems capable of carrying out the functionality described herein.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

1. A method, the method comprising:
loading a multi outlet digital microfluidic device dispenser with a liquid, the multi outlet digital microfluidic device dispenser comprising a first portion having a height that is different from a second portion of the multi outlet digital microfluidic device;
dispensing a first portion of the liquid from a first outlet;
dispensing a second portion of the liquid from a second outlet;
performing a first analysis on the first portion of the liquid;
performing a second analysis on the second portion of the liquid; and
presenting results of the first analysis and/or the second analysis.

2. The method of claim 1, wherein the first portion of the liquid is roughly the same amount as the second portion of the liquid.

3. (canceled)

4. The method of claim 1, wherein the method further comprises presenting results of the second analysis.

5. The method of claim 1, wherein the first analysis and the second analysis are the same analysis.

6. The method of claim 1, wherein the method further comprises dispensing the first portion of the liquid from a first outlet includes dispensing the first portion of the liquid to a first track.

7. The method of claim 6, wherein dispensing the second portion of the liquid from a second outlet includes dispensing the second portion of the liquid to a second track.

8. A system, the system comprising:
a multi outlet digital microfluidic device dispenser the multi outlet digital microfluidic device dispenser comprising a first portion having a height that is different from a second portion of the multi outlet digital microfluidic device;
a graphical user interface; and
a processor configured to:
load the multi outlet digital microfluidic device dispenser with a liquid;
dispense a first portion of the liquid from a first outlet;
dispense a second portion of the liquid from a second outlet;
perform a first analysis on the first portion of the liquid;
perform a second analysis on the second portion of the liquid; and
present results of the first analysis and/or second analysis on the graphical user interface.

9. The system of claim 8, wherein the first portion of the liquid is roughly the same amount as the second portion of the liquid.

10. (canceled)

11. The system of claim 8, the processor further configured to present results of the second analysis.

12. The system of claim 8, wherein the first analysis and the second analysis are the same analysis.

13. The system of claim 8, wherein dispensing the first portion of the liquid from a first outlet includes dispensing the first portion of the liquid to a first track.

14. The system of claim 13, wherein dispensing the second portion of the liquid from a second outlet includes dispensing the second portion of the liquid to a second track.

15.-21. (canceled)

22. A microfluidic cartridge, the cartridge comprising:
a top substrate;
a bottom substrate, the bottom substrate having a plurality of droplet operations electrodes, the bottom substrate and top substrate separated by a droplet operations gap therebetween; and
a plurality of multi-outlet dispensers operable to dispense a liquid; and
wherein said droplet operations electrodes include a plurality of dispending electrodes leading away from each of the plurality of multi-outlet dispensers;
the microfluidic cartridge comprising a first portion having a height that is different from a second portion of the microfluidic cartridge.

23. The microfluidic cartridge of claim 22, wherein the plurality of multi-outlet dispensers includes one or more dual-sided dispensers, wherein the dual-sided dispensers are operable to dispense a liquid from a first outlet and a second outlet.

24. The microfluidic cartridge of claim 22, wherein the plurality of multi-outlet dispensers includes one or more multi-sided dispensers, wherein the multi-sided dispensers are operable to dispense a liquid from multiple outlets.

25. (canceled)

26. The microfluidic cartridge of any one of claim 22, wherein the plurality of multi-outlet dispensers are arranged in an array, and wherein the array comprises one or more rows and/or one or more columns of multi-outlet dispensers.

27. The microfluidic cartridge of claim 22, wherein the cartridge further comprises one or more reservoirs, wherein the one or more reservoirs are in fluid communication with the plurality of multi-outlet dispensers. droplet operations electrodes

28. The microfluidic cartridge of claim 22, wherein the cartridge further comprises one or more detection mechanisms in fluid communication with the plurality of multi-outlet dispensers.

29. The microfluidic cartridge of claim 27, wherein the fluid communication comprises one or more of the droplet operations electrodes.

30. The microfluidic cartridge of claim 22, wherein each of the plurality of multi-outlet dispensers includes a liquid reagent or a liquid sample, and optionally wherein the liquid reagent is selected from a wash buffer, a ligand-containing reagent, an antigen-containing reagent, or a reactant-containing reagent.
